(19) United States
(12) Patent Application Publication
(10) Pub. No.: US 2022/0113082 A1
(43) Pub. Date: Apr. 14, 2022

(54) REFRIGERATOR

(71) Applicant: Toshiba Lifestyle Products & Services Corporation, Kawasaki-shi (JP)

(72) Inventors: Koichi AKIYOSHI, Kasugai-shi (JP); Kengo MATSUNAGA, Nagoya-shi (JP); Hiromichi MOTOI, Owariasahi-shi (JP)

(73) Assignee: Toshiba Lifestyle Products & Services Corporation, Kawasaki-shi (JP)

(21) Appl. No.: 17/420,565

(22) PCT Filed: Nov. 26, 2019
(86) PCT No.: PCT/JP2019/046138

§ 371 Date: Jul. 2, 2021

(30) Foreign Application Priority Data
Jan. 7, 2019 (JP) 2019-000856

(51) Int. Cl. F25D 23/06

(52) U.S. Cl. CPC F25D 23/063; F25D 2201/12; F25D 23/065

(57) ABSTRACT

A refrigerator including an insulating wall. The insulating wall includes an inner surface member, an outer surface member, a vacuum insulation material, an insulating member, and a foam insulation material. The inner surface member forms at least a portion of the inner surface of the refrigerator. The outer surface member forms at least a portion of the outer surface of the refrigerator. The vacuum insulation material is disposed between the inner surface member and the outer surface member. The insulating member is disposed between the vacuum insulation material and the inner surface member or between the vacuum insulation material and the outer surface member, and includes an aerogel, axerogel, or a cryogel. At least a portion of the foam insulation material is used to fill the space between the vacuum insulation material and the insulating member.

### TECHNICAL FIELD

Embodiments described herein relate generally to a refrigerator.

This application is based upon and claims the benefit of priority from Japanese Patent Application No. 2019-000856 filed in Japan on Jan. 7, 2019; the entire contents of (all of) which are incorporated herein by reference.

### BACKGROUND

Refrigerators with insulation are known. By the way, refrigerators are expected to have further improved heat insulating properties.

### Prior Art Document

[Patent Document 1] Japanese Unexamined Patent Application, First Publication No. 2004-340420

### SUMMARY

### Problems

An object to be solved by the present invention is to provide a refrigerator capable of improving heat insulation.

### Means

The refrigerator according to an embodiment has an insulating wall. The insulating wall includes an inner surface member, an outer surface member, a vacuum insulation material, an insulating member, and a foam insulation material. The inner surface member forms at least a portion of the inner surface of the refrigerator. The outer surface member forms at least a portion of the outer surface of the refrigerator. The vacuum insulation material is disposed between the inner surface member and the outer surface member. The insulating member is disposed between the vacuum insulation material and the inner surface member or between the vacuum insulation material and the outer surface member, and includes an aero gel, axerogel, or a cryogel. At least a portion of the foam insulation material is used to fill the space between the vacuum insulation material and the insulating member.

### BRIEF DESCRIPTION OF THE DRAWINGS

FIG. 1 is a front view showing a refrigerator according to the first embodiment.

FIG. 2 is a cross-sectional view of the refrigerator shown in FIG. 1 along the F2-F2 line.

FIG. 3 is a cross-sectional view showing the upper wall of the housing of the first embodiment.

FIG. 4 is an enlarged cross-sectional view showing a part of the upper wall shown in FIG. 3.

FIG. 5 is an enlarged cross-sectional view showing the rear end portion of the upper wall of the housing of the first embodiment.

FIG. 6 is an exploded perspective view showing circuit accommodating parts of the first embodiment.

FIG. 7 is a cross-sectional view taken along the line F7-F7 of the refrigerator 1 shown in FIG.

FIG. 8 is a front view showing an insulating member and an outer wall portion of the first embodiment.

FIG. 9 is an enlarged cross-sectional view showing an area surrounded by the F9 line of the refrigerator shown in FIG. 7.

FIG. 10 is a cross-sectional view showing a lower wall of the housing of the first embodiment.

FIG. 11 is a cross-sectional view taken along the line F11-F11 of the refrigerator shown in FIG.

FIG. 12 is an enlarged cross-sectional view showing a region surrounded by the F12 line on the left wall shown in FIG.

FIG. 13 is an exploded cross-sectional view showing the structure shown in FIG. 12.

FIG. 14 is a cross-sectional view of the refrigerator of the first embodiment as viewed from the front.

FIG. 15 is a front view showing an insulating member of the first embodiment.

FIG. 16 is a rear view showing the back surface of the first duct component of the first embodiment.

FIG. 17 is a cross-sectional view showing a first duct component and an insulating member according to the first embodiment.

FIG. 18 is a cross-sectional view showing a first defrost water receiver and a drainage pipe portion of the first embodiment.

FIG. 19 is a bottom view showing a first defrost water receiver and an insulating member according to the first embodiment.

FIG. 20 is a cross-sectional view showing the rear wall of the refrigerator of the second embodiment.

FIG. 21 is a cross-sectional view showing the left side wall of the refrigerator according to the third embodiment.

FIG. 22 is a cross-sectional view showing the vacuum insulation material of the third embodiment.

FIG. 23 is a front view showing an insulating member and an outer wall portion of the fourth embodiment.

FIG. 24 is a front view showing a refrigerator according to a fifth embodiment.

### DETAILED DESCRIPTION

Hereinafter, the refrigerator of the embodiment will be described with reference to the drawings. In the following description, configurations having the same or similar functions are designated by the same reference numerals. Then, the duplicate description of those configurations may be omitted. In this specification, the left and right are defined with reference to the direction in which a user standing in front of the refrigerator sees the refrigerator. In addition, when viewed from the refrigerator, the side closer to a user standing in front of the refrigerator is defined as “front”, and the side farther from the user is defined as “rear”. In the present specification, the “width direction” means the left-right direction in the above definition.

In the present specification, “ZZ is sandwiched between XX and YY” is not limited to the case where ZZ is in contact with XX and YY, but also includes the case where another member is interposed between ZZ and XX and between ZZ and YY, or both. As used herein, the term “contact” is not limited to the case of direct contact in a strict sense, but also includes the case where an adhesive layer such as an adhesive or an adhesive tape is present in between.

### First Embodiment

### 1. Overall Configuration of Refrigerator

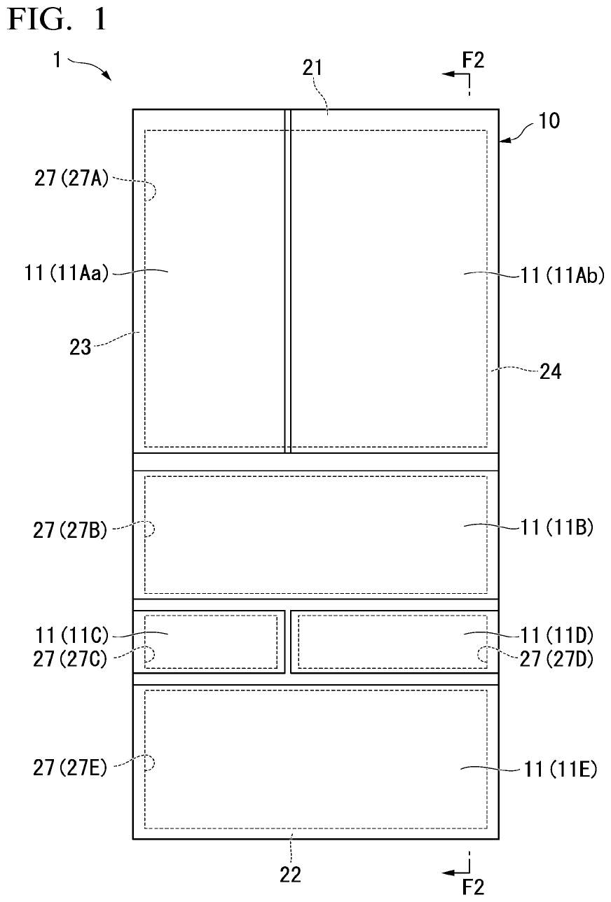

A refrigerator 1 of the first embodiment will be described with reference to FIGS. 1 to 19. First, the overall configuration of the refrigerator 1 will be described. However, the refrigerator 1 does not have to have all of the configurations described below, and some configurations may be omitted as appropriate.

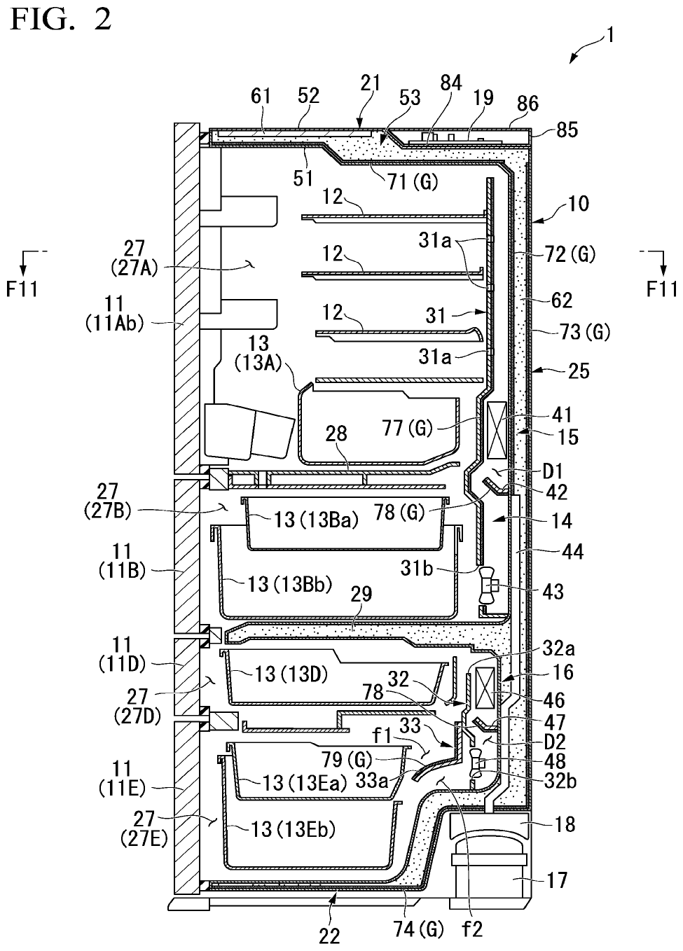

FIG. 1 is a front view showing the refrigerator 1. FIG. 2 is a cross-sectional view taken along the line F2-F2 of the refrigerator 1 shown in FIG. As shown in FIGS. 1 and 2, for example, the refrigerator 1 includes a housing 10, a plurality of doors 11, a plurality of shelves 12, a plurality of containers 13, a flow path forming component 14, a first cooling unit 15, a second cooling unit 16, a compressor 17, an evaporating dish 18, and a power supply circuit board 19.

The housing 10 has an upper wall 21, a lower wall 22, a left side wall 23, a right side wall 24, and a rear wall 25.

The upper wall 21 and the lower wall 22 extend substantially horizontally. The left side wall 23 and the right side wall 24 stand upward from the left end portion and the right end portion of the lower wall 22, respectively. The left side wall 23 and the right side wall 24 are connected to the left end portion and the right end portion of the upper wall 21, respectively. The rear wall 25 stands upward from the rear end of the lower wall 22 and is connected to the rear end of the upper wall 21. Each or a combination of the upper wall 21, the lower wall 22, the left side wall 23, the right side wall 24, and the rear wall 25 is an example of an “insulation wall”.

The configuration of the housing 10 will be described in detail later.

A plurality of storage chambers 27 are provided inside the housing 10. The plurality of storage chambers 27 include, for example, a refrigerator compartment 27A, a vegetable compartment 27B, an ice making chamber 27C, a small freezing chamber 27D, and a main freezing chamber 27E. In the present embodiment, the refrigerating chamber 27A is arranged at the uppermost part, the vegetable compartment 27B is arranged below the refrigerating chamber 27A, the ice making chamber 27C and the small freezing chamber 27D are arranged below the vegetable chamber 27B, and the main freezing chamber 27E is arranged below the ice making chamber 27C and the small freezing chamber 27D. However, the arrangement of the storage chamber 27 is not limited to the above example, and the arrangement of the vegetable chamber 27B and the main freezing chamber 27E may be reversed, for example. The housing 10 has an opening on the front side of each storage chamber 27 that allows food to be taken in and out of each storage chamber 27.

The housing 10 has a first partition 28 and a second partition 29. The first partition 28 and the second partition 29 are, for example, partition walls that are substantially horizontal to each other. The first partition 28 is located between the refrigerator compartment 27A and the vegetable compartment 27B, and partitions the refrigerator compartment 27A and the vegetable compartment 27B. For example, the first partition 28 forms the bottom wall of the refrigerator compartment 27A and the ceiling wall of the vegetable compartment 27B. On the other hand, the second partition 29 is located between the vegetable compartment 27B and the ice making chamber 27C and partitions the vegetable compartment 27B from the ice making chamber 27C and the small freezing chamber 27D. For example, the second partition 29 forms the bottom wall of the vegetable compartment 27B and the ceiling walls of the ice making chamber 27C and the small freezing chamber 27D.

The openings of the plurality of storage chambers 27 are closed by a plurality of doors 11 so as to be openable and closable. The plurality of doors 11 include, for example, the left refrigerating room door 11Aa that closes the opening of the refrigerating room 27A, the right refrigerating room door 11Ab, the vegetable room door 11B that closes the opening of the vegetable room 27B, the ice making chamber door 11C that closes the opening of the ice making chamber 27C, the small freezer door 11D that closes the opening of the small freezer 27D, and the main freezer door 11E that closes the opening of the main freezer 27E.

The plurality of shelves 12 are provided in the refrigerator compartment 27A.

The plurality of containers 13 include a refrigerating room container 13A, a first vegetable room container 13Ba, a second vegetable room container 13Bb, an ice making chamber container (not shown), a small freezing room container 13D, a first main freezing room container 13Ea, and a second main freezer container 13Eb.

The refrigerating chamber container 13A is provided in the refrigerating chamber 27A, and is, for example, a chilled chamber container. The first vegetable compartment container 13Ba and the second vegetable compartment container 13Bb are provided in the vegetable compartment 27B. The ice making chamber container (not shown) is provided in the ice making chamber 27C. The small freezer container 13D is provided in the small freezer 27D. The first main freezing chamber container 13Ea and the second main freezing chamber container 13Eb are provided in the main freezing chamber 27E.

The flow path forming component 14 is arranged in the housing 10. The flow path forming component 14 includes a first duct component 31, a second duct component 32, and a return flow path cover 33.

The first duct component 31 is provided along the rear wall 25 of the housing 10 and extends in the vertical direction. The first duct component 31 extends from the rear of the lower end of the vegetable compartment 27B to the rear of the upper end of the refrigerator compartment 27A, for example. A first duct space D1, which is a passage through which cold air (air) flows, is formed between the first duct component 31 and the rear wall 25 of the housing 10. The first duct component 31 has a plurality of cold air outlets 31a and a cold air return port 31b. The plurality of cold air outlets 31a are provided at a plurality of height positions in the refrigerating chamber 27A. The cold air return port 31b is provided at the lower end of the first duct component 31 and is located behind the vegetable compartment 27B.

The second duct component 32 is provided along the rear wall 25 of the housing 10 and extends in the vertical direction. The second duct component 32 extends from the rear of the main freezing chamber 27E to the rear of the upper ends of the ice making chamber 27C and the small freezing chamber 27D, for example. A second duct space D2, which is a passage through which cold air (air) flows, is formed between the second duct component 32 and the rear wall 25 of the housing 10. The second duct component 32 has a cold air outlet 32a and a cold air return port 32b. The cold air outlet 32a is provided at the upper end of the second duct component 32 and is located behind the ice making chamber 27C and the small freezing chamber 27D. The cold air return port 32b is provided at the lower end of the second duct component 32 and is located behind the main freezing chamber 27E.

The return flow path cover 33 is arranged in, for example, the main freezing chamber 27E. The return flow path cover 33 is provided at the rear portion in the housing 10. The return flow path cover 33 includes a wall portion 33a located at a height between the cold air outlet 32a and the cold air return port 32b of the second duct component 32 in the vertical direction of the refrigerator 1. The return flow path cover 33 divides the rear portion of the housing 10 into a cold air flow path f1 and a return flow path f2 behind the main freezing chamber 27E.

The cold air flow path f1 communicates with the cold air outlet 32a of the second duct component 32 at the rear portion of the housing 10. The cold air flow path f1 is a flow path through which the cold air cooled by the second cooler 46 described later and blown out from the cold air outlet 32a passes. For example, the cold air flow path f1 is a flow path through which cold air passes from the cold air outlet 32a toward the main freezing chamber 27E.

The return flow path f2 communicates with the cold air return port 32b of the second duct component 32 at the rear portion of the housing 10. The return flow path f2 is a flow path in which cold air that has passed through one or more of the ice making chamber 27C, the small freezing chamber 27D, and the main freezing chamber 27E returns to the second cooler 46. At least a part of the return flow path f2 is located below the cold air flow path f1.

In the return flow path cover 33, cold air flows in opposite directions on the first surface side facing the cold air flow path f1 and the second surface side facing the return flow path f2.

The first cooling unit 15 is a cooling unit that cools the refrigerator compartment 27A and the vegetable compartment 27B. The first cooling unit 15 includes, for example, a first cooler 41, a first defrost water receiver 42, and a first fan 43.

The first cooler 41 is arranged in the first duct space D1. The first cooler 41 is arranged at a height corresponding to the lower end of the refrigerating chamber 27A, for example. The refrigerant compressed by the compressor 17, which will be described later, is supplied to the first cooler 41. The first cooler 41 cools the cold air flowing through the first duct space D1.

The first defrost water receiver 42 is arranged in the first duct space D1 and is provided below the first cooler 41. The first defrost water receiver 42 receives the defrost water generated by the first cooler 41 (the defrost water dripping from the first cooler 41). The defrosted water received by the first defrosted water receiver 42 is guided to the evaporating dish 18 via the drain pipe portion 44 provided on the rear wall 25 of the housing 10.

The first fan 43 is provided, for example, at the cold air return port 31b of the first duct component 31. When the first fan 43 is driven, the air in the vegetable compartment 27B flows into the first duct space D1 from the cold air return port 31b. The air that has flowed into the first duct space D1 flows upward in the first duct space D1 and is cooled by the first cooler 41. The cold air cooled by the first cooler 41 is blown out to the refrigerating chamber 27A from the plurality of cold air outlets 31a. The cold air blown out to the refrigerating chamber 27A flows through the refrigerating chamber 27A, passes through the vegetable compartment 27B, and returns to the cold air return port 31b again. As a result, the cold air flowing through the refrigerating chamber 27A and the vegetable compartment 27B is circulated in the refrigerator 1, and the refrigerating chamber 27A and the vegetable compartment 27B are cooled.

On the other hand, the second cooling unit 16 is a cooling unit that cools the ice making chamber 27C, the small freezing chamber 27D, and the vegetable compartment 27B. The second cooling unit 16 includes, for example, a second cooler 46, a second defrost water receiver 47, and a second fan 48.

The second cooler 46 is arranged in the second duct space D2. The second cooler 46 is arranged at a height corresponding to, for example, the small freezer chamber 27D. A refrigerant compressed by a compressor 17, which will be described later, is supplied to the second cooler 46. The second cooler 46 cools the cold air flowing through the second duct space D2.

The second defrost water receiver 47 is arranged in the second duct space D2 and is provided below the second cooler 46. The second defrost water receiver 47 receives the defrost water generated by the second cooler 46 (the defrost water dropped from the second cooler 46). The defrost water received by the second defrost water receiver 47 is guided to the evaporating dish 18 via the drain pipe portion 44 provided on the rear wall 25 of the housing 10.

The second fan 48 is provided, for example, at the cold air return port 32b of the second duct component 32. When the second fan 48 is driven, the air in the main freezing chamber 27E flows into the second duct space D2 from the cold air return port 32b. The air that has flowed into the second duct space D2 flows upward in the second duct space D2 and is cooled by the second cooler 46. The cold air cooled by the second cooler 46 flows into the ice making chamber 27C, the small freezing chamber 27D, and the main freezing chamber 27E from the cold air outlet 32a. The cold air that has flowed into the ice making chamber 27C and the small freezing chamber 27D flows through the ice making chamber 27C and the small freezing chamber 27D, and then returns to the cold air return port 32b again via the main freezing chamber 27E. As a result, the cold air flowing in the ice making chamber 27C, the small freezing chamber 27D, and the main freezing chamber 27E is circulated in the refrigerator 1, and the ice making chamber 27C, the small freezing chamber 27D, and the main freezing chamber 27E are cooled.

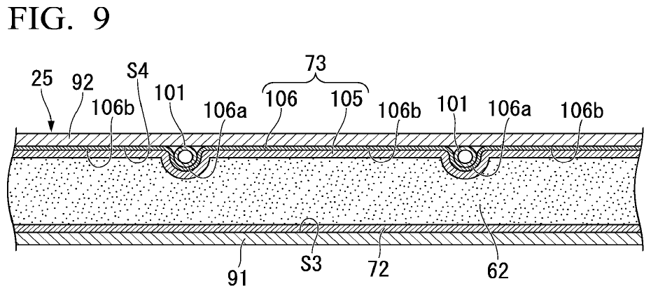

The compressor 17 is provided, for example, in the machine room at the bottom of the refrigerator 1. The compressor 17 compresses the refrigerant gas used for cooling the storage chamber 27. The refrigerant gas compressed by the compressor 17 is sent to the first cooler 41 and the second cooler 46 via the heat radiating pipe 101 (see FIG. 9) and the like.

The evaporating dish 18 is provided, for example, in the machine room at the bottom of the refrigerator 1. The evaporating dish 18 is heated by, for example, the heat generated by the compressor 17 to evaporate the defrosted water led from the first defrosted water receiver 42 and the second defrosted water receiver 47 to the evaporating dish 18.

The power supply circuit board 19 is electrically connected to a commercial power source (AC 100V) which is an external power source. The power supply circuit board 19 converts the electric power supplied from the commercial power source into DC electric power having a voltage suitable for driving each electric component included in the refrigerator 1. The power supply circuit board 19 supplies the converted DC power to each electric component of the refrigerator 1. The power supply circuit board 19 is an example of a heat-generating component that generates a large amount of heat in the refrigerator 1.

The power supply circuit board 19 is provided on, for example, the upper wall 21 of the housing 10. In the present embodiment, the upper surface of the upper wall 21 of the housing 10 has a recess 84 recessed downward. The power supply circuit board 19 is arranged in the recess 84.

The installation configuration of the power supply circuit board 19 will be described in detail later.

### 2. Overall Configuration of the Housing

Next, the configuration of the housing 10 will be described.

As shown in FIG. 2, the housing 10 has, for example, an inner box 51, an outer box 52, and a heat insulating portion 53.

The inner box 51 is a member that forms the inner surface of the housing 10, and is made of, for example, a synthetic resin. The inner box 51 may form the entire inner surface of the housing 10, or may form only a part of the inner surface. The inner box 51 is a member exposed to the storage chamber 27 (refrigerator chamber 27A, vegetable compartment 27B, ice making chamber 27C, small freezing chamber 27D, and main freezing chamber 27E). The inner box 51 is an example of an “inner surface member”.

The outer box 52 is a member that forms the outer surface of the housing 10, and is made of metal, for example. The outer box 52 may form the entire outer surface of the housing 10, or may form only a part of the outer box 52. The outer box 52 is formed to be one size larger than the inner box 51, and is arranged outside the inner box 51. The outer box 52 is a member exposed to the outside of the refrigerator 1. Between the inner box 51 and the outer box 52, there is a space provided with a heat insulating portion 53, which will be described later. The outer box 52 is an example of an “outer surface member”.

The heat insulating portion 53 is provided between the inner box 51 and the outer box 52 to enhance the heat insulating property of the housing 10. The heat insulating portion 53 includes, for example, a vacuum insulation material (VIP: Vacuum Insulation Panel) 61, a foam insulation material 62, and a plurality of insulating members 71 to 76 (see FIG. 12 for insulating members 75 and 76). These will be described below.

### 3. Material of Each Member of the Heat Insulating Part

First, the individual materials of the vacuum insulation material 61, the foam insulation material 62, and the plurality of insulating members 71 to 76 will be described.

The vacuum insulation material 61 is, for example, a heat insulation material containing an exterior body and a core material housed in the exterior body, and the inside of the exterior body is depressurized. The core material is, for example, a fiber material such as glass wool or a porous body such as a foam.

The foam insulation material 62 is a foam insulation material such as urethane foam. The foam insulation material 62 is formed by being injected between the inner box 51 and the outer box 52 in a fluid state, being injected between the inner box 51 and the outer box 52, and then foaming.

Each of the plurality of insulating members 71 to 76 is formed of a heat insulation material G containing aerogel, xerogel, or cryogel (hereinafter, referred to as “specific heat insulation material G” for convenience of explanation).

Here, “including one or more of aerogel, xerogel, or cryogel” is used to mean “including one or more of aerogel, xerogel, or cryogel”. Aerogel, xerogel, and cryogel are low-density structures (dry gels), respectively. The “aerogel” is, for example, a porous substance in which the solvent contained in the gel is replaced with a gas by supercritical drying. The “xerogel” is a porous substance in which the solvent contained in the gel is replaced with a gas by evaporation drying. The “cryogel” is a porous substance in which the solvent contained in the gel is replaced with a gas by freeze-drying.

It should be noted that some aerogels can be dried without using supercritical drying by introducing, for example, a specific element. The term “aerogel” as used herein also includes such an aerogel. That is, the term “aerogel” as used herein is not limited to those manufactured by using supercritical drying, and broadly means various materials distributed as “aerogel”. As an aerogel that does not require supercritical drying, for example, an organic-inorganic hybrid aerogel in which an organic chain such as a methyl group is introduced into a molecular network of silicon dioxide is known, and there is a PMSQ (CH3SiO1.5) aerogel. However, these are just examples.

Aerogel, xerogel, and cryogel are ultra-low density dry porous bodies having a large number of fine pores (voids) and an extremely high porosity (porosity of 90% or more, preferably 95% or more). The density of the dry porous body is, for example, 150 mg/cm3 or less. Aerogels, xerogels, and cryogels have, for example, a structure in which silicon dioxide and the like are bonded in a bead shape, and have a large number of nanometer-level (for example, 100 nm or less, preferably 2 nm to 50 nm) voids. Since they have nanometer-level pores and a lattice structure in this way, the mean free path of gas molecules can be reduced, the heat conduction between gas molecules is very small even at normal pressure, and the thermal conductivity is very small. For example, aerogels, xerogels, and cryogels have fine voids that are smaller than the mean free path of air.

The aerogel, xerogel, and cryogel may be an inorganic aerogel, an inorganic xerogel, or an inorganic cryogel composed of metal oxides such as silicon, aluminum, iron, copper, zirconium, hafnium, magnesium, and yttrium, and may be, for example, a silica aerogel, silica xerogel, or silica cryogel containing silicon dioxide. For example, silica-based dry gels such as silica aerogel, silica xerogel, and silica cryogel have a structure in which silica (SiO2) fine particles having a diameter of 10 nm to 20 nm are connected, and have pores having a width of several tens of nm. Silica-based dry gel has extremely low heat conduction in solid parts due to its low density, and the movement of air inside the pores is restricted, thereby exhibiting a very low thermal conductivity (0.012 W/(m·K) to 0.02 W/(m·K)). Further, the silica-based dry gel has high light transmittance because the silica fine particles and pores are smaller than the wavelength of visible light and do not scatter visible light.

For example, the material constituting the aerogel, the xerogel, and the cryogel may be carbon or the like.

In aerogels, xerogels, and cryogels, by selecting a material, it is possible to provide appropriate properties (for example, elasticity, flexibility, etc.) according to the material. For example, by using a resin such as polypropylene as a material for an aerogel, xerogel, and cryogel, the aerogel, xerogel, and cryogel can be provided with high elasticity or flexibility.

The aerogel, xerogel, and cryogel may each form the specific heat insulation material G by themselves.

Aerogel, xerogel, and cryogel may each form a specific heat insulation material G which is a composite heat insulation material by immersing another material (for example, a fiber structure) in the state of a precursor. In this case, the fiber structure functions as a reinforcing material for reinforcing the dry gel or a support for supporting the dry gel.

As the fiber structure, a flexible woven fabric, knitted fabric, non-woven fabric or the like is used in order to obtain a flexible composite heat insulation material, and more preferably felt or blanket (soft brushed material) is used. As the material of the fiber structure, for example, organic fibers such as polyester fibers, inorganic fibers such as glass fibers, organic and inorganic composite fibers and the like can be used.

The fiber structure may be, for example, the natural polymer chitosan. In this case, the specific heat insulation material G contains a three-dimensional network structure of hydrophobized fine chitosan fibers, and has an ultra-high porosity (96 to 97% of the volume is void). Such a specific heat insulation material G has water repellency because the moisture resistance, which is a problem of a material made of polysaccharide nanofibers, is enhanced while maintaining a homogeneous nanostructure of hydrophilic chitosan aerogel by hydrophobization.

The specific heat insulation material G may be, for example, a heat insulation material in which one or more dry gels selected from the group consisting of silica aerogel, xerogel, and cryogel and polypropylene foam are composited.

The thermal conductivity of the specific heat insulation material G is higher than the thermal conductivity of the vacuum insulation material 61 (an example of a general vacuum insulation material), but is lower than the thermal conductivity of the foam insulation material 62 (an example of a general foam insulation material). That is, the heat insulating property of the specific heat insulation material G is not as good as the heat insulating property of the vacuum insulation material 61, but is superior to the heat insulating property of the foam insulation material 62. The thermal conductivity of the specific heat insulation material G is, for example, 0.010 W/(m·K) to 0.015 W/(m·K). The thermal conductivity of the vacuum insulation material 61 is, for example, 0.003 W/(m·K) to 0.005 W/(m·K). The thermal conductivity of the foam insulation material 62 is, for example, 0.020 W/(m·K) to 0.022 W/(m·K). However, these numerical values are merely examples.

When the specific heat insulation material G has flexibility, the flexibility (flexibility) of the specific heat insulation material G is higher than, for example, the flexibility of the vacuum insulation material 61 and higher than the flexibility of the foam insulation material 62. Further, when the specific heat insulation material G has elasticity, the elasticity of the specific heat insulation material G is higher than, for example, the elasticity of the vacuum insulation material 61 (substantially close to inelasticity), and is higher than the elasticity of the foam insulation material 62 (substantially close to inelasticity).

### 4. Arrangement of Each Member of the Heat Insulating Part

Next, the arrangement of the vacuum insulation material 61, the foam insulation material 62, and the plurality of insulating members 71 to 76 will be described. The configuration of each wall portion described below may be applied to another wall portion. That is, the configuration described as the configuration relating to the upper wall 21 may be applied to the lower wall 22, the left side wall 23, the right side wall 24, and the rear wall 25, which will be described later.

### 4.1 Upper Wall of Housing

First, the upper wall 21 of the housing 10 will be described. The upper wall 21 includes, for example, a vacuum insulation material 61, a foam insulation material 62, and an insulating member 71. The insulating member 71 is an example of the “first insulating member”.

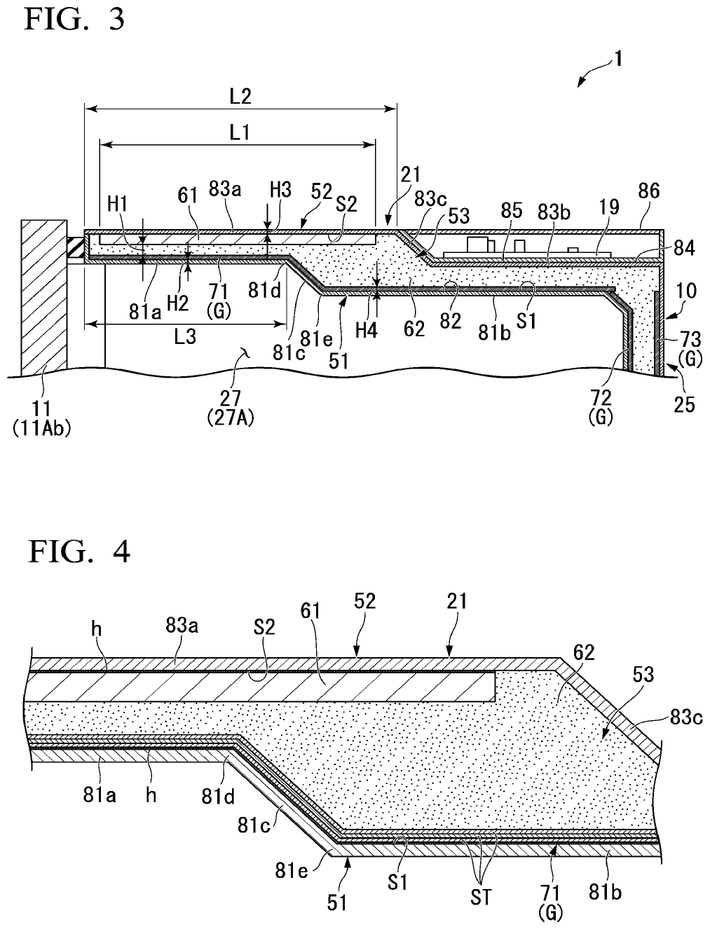

FIG. 3 is a cross-sectional view showing the upper wall 21 of the housing 10. The inner box 51 has a first inner wall portion 81a, a second inner wall portion 81b, and an inclined inner wall portion (third inner wall portion) 81c included in the upper wall 21 of the housing 10.

The first inner wall portion 81a extends substantially horizontally from the front end of the housing 10 toward the rear.

The second inner wall portion 81b is located behind the first inner wall portion 81a and extends substantially horizontally. The second inner wall portion 81b is located at a lower height than the first inner wall portion 81a. The second inner wall portion 81b includes a portion located below the recess 84 of the outer box 52, which will be described later. The inclined inner wall portion 81c is provided between the first inner wall portion 81a and the second inner wall portion 81b, and is inclined obliquely with respect to the horizontal direction.

The inclined inner wall portion 81c connects the rear end of the first inner wall portion 81a and the front end of the second inner wall portion 81b. A first corner portion 81d is provided between the first inner wall portion 81a and the inclined inner wall portion 81c. A second corner portion 81e is provided between the second inner wall portion 81b and the inclined inner wall portion 81c.

In the inner box 51, the second inner wall portion 81b and the inclined inner wall portion 81c form a recess 82 recessed downward with respect to the first inner wall portion 81a on the upper surface side thereof.

Further, the inner box 51 has a wall surface S1 facing a region (that is, a heat insulating portion 53) between the inner box 51 and the outer box 52. The wall surface S1 is the upper surface of the first inner wall portion 81a, the second inner wall portion 81b, and the inclined inner wall portion 81c. The wall surface S1 has a wall surface shape corresponding to the shapes of the first inner wall portion 81a, the second inner wall portion 81b, and the inclined inner wall portion 81c. That is, the wall surface S1 has a wall surface shape including the recess 82 described above.

The outer box 52 has a first outer wall portion 83a, a second outer wall portion 83b, and an inclined outer wall portion (third outer wall portion) 83c included in the upper wall 21 of the housing 10.

The first outer wall portion 83a extends substantially horizontally from the front end of the housing 10 toward the rear. The first outer wall portion 83a extends to the rear of the first inner wall portion 81a.

The second outer wall portion 83b is located behind the first outer wall portion 83a and extends substantially horizontally. The second outer wall portion 83b is located at a lower height than the first outer wall portion 83a.

The inclined outer wall portion 83c is provided between the first outer wall portion 83a and the second outer wall portion 83b, and is inclined obliquely with respect to the horizontal direction. The inclined outer wall portion 83c connects the rear end of the first outer wall portion 83a and the front end of the second outer wall portion 83b.

In the outer box 52, the second outer wall portion 83b and the inclined outer wall portion 83c form a recess 84 on the upper surface side thereof, which is recessed downward with respect to the first outer wall portion 83a and in which the power supply circuit board 19 is arranged.

The outer box 52 has a wall surface S2 facing a region (that is, a heat insulating portion 53) between the inner box 51 and the outer box 52. The wall surface S2 is the lower surface of the first outer wall portion 83a, the second outer wall portion 83b, and the inclined outer wall portion 83c. The wall surface S2 has a wall surface shape corresponding to the shapes of the first outer wall portion 83a, the second outer wall portion 83b, and the inclined outer wall portion 83c.

The vacuum insulation material 61 is arranged between the inner box 51 and the outer box 52. The vacuum insulation material 61 is arranged along the wall surface S2 in the first outer wall portion 83a of the outer box 52. The vacuum insulation material 61 is fixed to the wall surface S2 of the first outer wall portion 83a of the outer box 52 by, for example, an adhesive layer h (see FIG. 4) which is an adhesive or an adhesive tape, and is in contact with the wall surface S2 of the first outer wall portion 83a of the outer box 52. However, the vacuum insulation material 61 may be fixed to the outer box 52 by a fastening member or a support structure (not shown).

In the present embodiment, the length L1 in the front-rear direction of the vacuum insulation material 61 is shorter than the length L2 in the front-rear direction of the first outer wall portion 83a and longer than the length L3 in the front-rear direction of the first inner wall portion 81a. The vacuum insulation material 61 is attached within the range of the wall surface S2 in the first outer wall portion 83a.

The insulating member 71 is arranged between the inner box 51 and the outer box 52. In the present embodiment, at least a part of the insulating member 71 is arranged between the vacuum insulation material 61 and the inner box 51. The insulating member 71 is arranged along the wall surface Si of the inner box 51. The insulating member 71 is fixed to the wall surface Si of the inner box 51 by, for example, the adhesive layer h, and is in contact with the wall surface Si of the inner box 51.

That is, in the present embodiment, when the outer box 52 is the first member and the inner box 51 is the second member, the vacuum insulation material 61 is attached to the first member and the insulating member 71 is attached to the second member.

In the present embodiment, the insulating member 71 has a size over substantially the entire area of the first inner wall portion 81a, the inclined inner wall portion 81c, and the second inner wall portion 81b. The insulating member 71 is formed in the form of a flexible sheet. Further, the insulating member 71 is deformed into a shape along the wall surface shape of the inner box 51 including the recess 82, and is arranged along the wall surface S1 of the inner box 51. That is, the insulating member 71 is also arranged along the inner surface of the recess 82.

More specifically, the insulating member 71 is bent so as to be continuously along the first inner wall portion 81a, the first corner portion 81d, the inclined inner wall portion 81c, the second corner portion 81e, and the second inner wall portion 81b, and is arranged along the first inner wall portion 81a, the inclined inner wall portion 81c, and the second inner wall portion 81b, respectively. For example, the insulating member 71 is fixed to the first inner wall portion 81a, the inclined inner wall portion 81c, and the second inner wall portion 81b by, for example, the adhesive layer h, respectively, and is in contact with the first inner wall portion 81a, the inclined inner wall portion 81c, and the second inner wall portion 81b, respectively. The first inner wall portion 81a is an example of the “first wall portion”. The inclined inner wall portion 81c is an example of the “second wall portion”. When the insulating member 71 is formed in a flexible sheet shape, prior shape processing becomes unnecessary, and the manufacturability of the refrigerator 1 can be improved.

The wall surface S1 may have a convex portion protruding toward the wall surface S2 of the outer box 52 in place of the concave portion 82 or in addition to the concave portion 82. In this case, the insulating member 71 is formed in a sheet shape, for example, and is deformed and arranged along the surface of the convex portion.

Further, the insulating member 71 may have a certain degree of hardness without having flexibility. In this case, the insulating member 71 may be formed in advance in a shape along the wall surface shape of the inner box 51 including the concave portion 82 (or the convex portion) by, for example, press working. After this, the insulating member 71 may be combined with the inner box 51 and arranged along the wall surface S1 of the inner box 51. According to such a configuration, the insulating member 71 is unlikely to be displaced during assembly, so that the assembly workability can be improved.

At least a part of the foam insulation material 62 is filled between the vacuum insulation material 61 and the insulating member 71. In the region where the vacuum insulation material 61 is not arranged, the foam insulation material 62 is filled between the wall surface S2 of the outer box 52 and the insulating member 71.

The space between the vacuum insulation material 61 and the insulating member 71 in the thickness direction of the upper wall 21 serves as a flow path through which the foam insulation material 62 before foaming flows when the foam insulation material 62 before foaming is filled during the manufacture of the housing 10. In the present embodiment, the distance H1 (for example, the minimum distance) between the vacuum insulation material 61 and the insulating member 71 in the thickness direction of the upper wall 21 is larger than the thickness H2 of the inner box 51 in the thickness direction of the upper wall 21, and is larger than the thickness H3 of the outer box 52 in the thickness direction of the upper wall 21. From another point of view, the distance H1 (for example, the minimum distance) between the vacuum insulation material 61 and the insulating member 71 in the thickness direction of the upper wall 21 is larger than the thickness H4 of the insulating member 71 in the thickness direction of the upper wall 21. According to such a configuration, the foam insulation material 62 easily flows into the gap between the vacuum insulation material 61 and the insulating member 71, and it is possible to prevent the foam insulation material 62 from being insufficiently filled in the gap between the vacuum insulation material 61 and the insulating member 71 and in other parts of the upper wall 21.

Next, an example of the insulating member 71 will be described in more detail.

FIG. 4 is an enlarged cross-sectional view showing a part of the upper wall 21 shown in FIG. 3. The insulating member 71 is formed by, for example, laminating a plurality of sheets ST. Each of the plurality of sheets ST is formed of the specific heat insulation material G and has flexibility.

According to such a configuration, even if the wall surface shape of the wall surface S1 of the inner box 51 is complicated, the insulating member 71 has flexibility, so that the insulating member 71 can be easily arranged along the wall surface S1 of the inner box 51.

For example, in the above configuration, the number of sheets ST to be laminated may be increased in the portion requiring higher heat insulation than in the other portions. In this case, it becomes easier to achieve both the improvement of the heat insulating property and the expansion of the internal volume of the refrigerator 1.

The configuration of the insulating member 71 described above may be applied to the configurations of other insulating members 72, 73, 74, 75, 76, 77, 78, 79, 89, 173 described below.

### 4.2 Installation Configuration of Power Supply Circuit

Next, the installation configuration of the power supply circuit board 19 will be described.

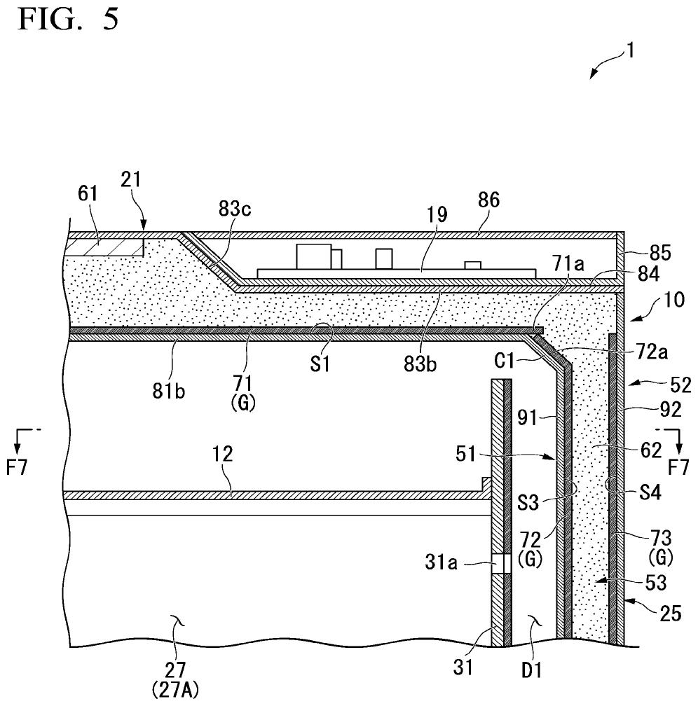

FIG. 5 is an enlarged cross-sectional view showing the rear end portion of the upper wall 21 of the housing 10. In this embodiment, the refrigerator 1 has a circuit accommodating component 85 and a cover 86. The circuit accommodating component 85 is formed in a bowl shape along the recess 84 of the upper wall 21 and is arranged in the recess 84 of the upper wall 21. The circuit accommodating component 85 is fixed to the outer box 52 by a fastening member (not shown).

The cover 86 covers the power supply circuit board 19 housed in the circuit housing component 85 from above.

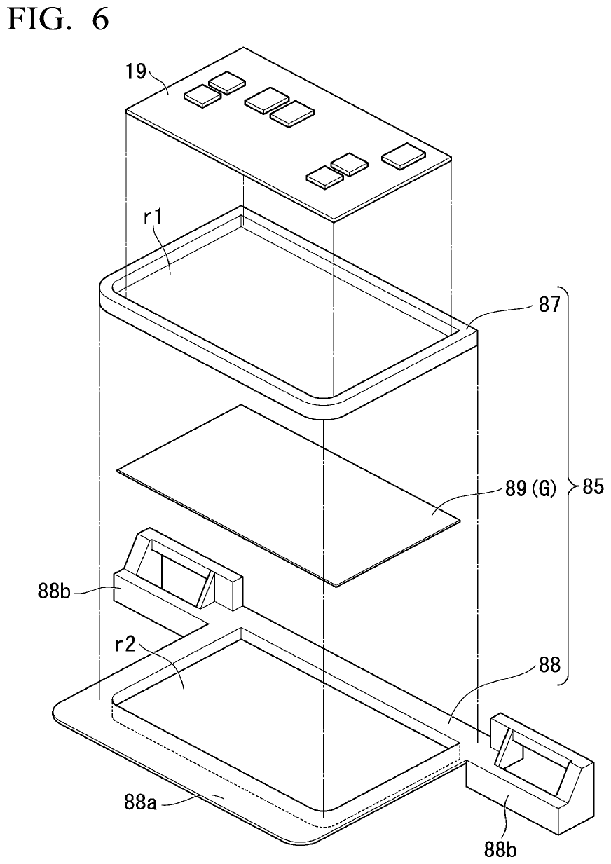

FIG. 6 is an exploded perspective view showing the circuit accommodating component 85. In this embodiment, the circuit accommodating component 85 includes an upper tray 87, a lower tray 88, and an insulating member 89.

The upper tray 87 is formed in a bowl shape including a recess r1 which is one size larger than the power supply circuit board 19. The upper tray 87 is made of a material having electrical insulation and flame retardancy. The power supply circuit board 19 is housed inside the recess r1 of the upper tray 87.

The lower tray 88 has a tray main body portion 88a and a pair of handles 88b. The tray body 88a is formed in a bowl shape including a recess r2 that is one size larger than the upper tray 87. The pair of handles 88b are provided on the left and right sides of the tray main body portion 88a.

The insulating member 89 is formed of the above-mentioned specific heat insulation material G. The insulating member 89 is attached to the upper surface of the recess r2 of the lower tray 88 and is located between the upper tray 87 and the lower tray 88. That is, the insulating member 89 is located between the power supply circuit board 19 and the housing 10 of the refrigerator 1.

The insulating member 89 has a larger area than, for example, the power supply circuit board 19. The insulating member 89 suppresses the heat generated by the power supply circuit board 19 from being transferred from the upper tray 87 to the lower tray 88. As a result, the heat generated by the power supply circuit board 19 is less likely to be transferred to the refrigerating chamber 27A.

However, the mounting position of the insulating member 89 is not limited to the upper surface of the recess r2 of the lower tray 88. For example, the insulating member 89 may be attached to the upper surface of the recess r1 of the upper tray 87, may be attached to the lower surface of the upper tray 87, may be attached to the lower surface of the lower tray 88, and may be attached to the upper wall 21 of the housing 10.

Either one or both of the upper tray 87 and the lower tray 88 may be formed of the specific heat insulation material G, a synthetic resin containing the specific heat insulation material G, or the like.

### 4.3 Rear Wall of Housing

### 4.3.1 Outline of Rear Wall

Next, returning to FIG. 5, the rear wall 25 of the housing 10 will be described. The rear wall 25 includes, for example, an insulating member 72 (inner insulating member), an insulating member 73 (outer insulating member), and a foam insulation material 62. The insulating member 72 is an example of the “second insulating member”. The insulating member 73 is an example of the “third insulating member”.

The inner box 51 includes an inner wall portion 91 included in the rear wall 25 of the housing 10. The inner wall portion 91 extends in the vertical direction. The inner wall portion 91 has a wall surface S3 facing a region (that is, a heat insulating portion 53) between the inner box 51 and the outer box 52. Similarly, the outer box 52 has an outer wall portion 92 included in the rear wall 25 of the housing 10. The outer wall portion 92 extends in the vertical direction. The outer wall portion 92 has a wall surface S4 facing a region (that is, a heat insulating portion 53) between the inner box 51 and the outer box 52.

The inner insulating member 72 is arranged between the inner wall portion 91 of the inner box 51 and the outer wall portion 92 of the outer box 52. The insulating member 72 is formed of the above-mentioned specific heat insulation material G. The insulating member 72 is arranged along the wall surface S3 of the inner box 51. For example, the insulating member 72 is fixed to the wall surface S3 of the inner box 51 by an adhesive layer similar to the adhesive layer h described above, and is in contact with the wall surface S3 of the inner box 51.

Although not shown in FIG. 2, for example, the insulating member 72 is provided over substantially the entire height of the rear wall 25 so as to extend from the vicinity of the compressor 17 to the vicinity of the upper end portion of the refrigerating chamber 27A. That is, the insulating member 72 passes from the rear of the cold air return port 32b and the second fan 48 of the second duct component 32, behind the second cooler 46, the first fan 43, and the first cooler 41, and behind the plurality of cold air outlets 31a of the first duct component 31.

As shown in FIG. 5, the outer insulating member 73 is arranged between the inner wall portion 91 of the inner box 51 and the outer wall portion 92 of the outer box 52. The insulating member 73 is made of the above-mentioned specific heat insulation material G. The insulating member 73 is arranged along the wall surface S4 of the outer box 52. For example, the insulating member 73 is fixed to the wall surface S4 of the outer box 52 by an adhesive layer similar to the adhesive layer h described above, and is in contact with the wall surface S4 of the outer box 52.

For example, the insulating member 73 is provided over substantially the entire height of the rear wall 25 so as to extend from the vicinity of the compressor 17 to the vicinity of the upper end of the refrigerating chamber 27A (see FIG. 2). That is, the insulating member 73 is provided from the cold air return port 32b of the second duct component 32 and the rear of the second fan 48, behind the second cooler 46, the first fan 43, and the first cooler 41, and behind the plurality of cold air outlets 31a of the first duct component 31. The insulating member 73 faces the insulating member 72 with the foam insulation material 62 in between in the front-rear direction of the refrigerator 1.

The foam insulation material 62 is filled between the two insulating members 72 and 73. From another point of view, the foam insulation material 62 is filled between the inner wall portion 91 of the inner box 51 and the insulating member 73 (outer insulating member). From another point of view, the foam insulation material 62 is filled between the insulating member 72 (inner insulating member) and the outer wall portion 92 of the outer box 52.

### 4.3.2 Configuration Related to Inner Insulating Member (1)

Next, the configuration regarding the inner insulating member 72 will be described.

The wall surface S3 of the inner wall portion 91 of the rear wall 25 extends in a direction different from that of the wall surface S1 of the second inner wall portion 81b of the upper wall 21. A corner portion c1 is provided between the wall surface S1 of the second inner wall portion 81b of the upper wall 21 and the wall surface S3 of the inner wall portion 91 of the rear wall 25. The wall surface S1 of the second inner wall portion 81b of the upper wall 21 is an example of the “first wall surface”. The wall surface S3 of the inner wall portion 91 of the rear wall 25 is an example of the “second wall surface”. The “corner portion” referred to in the present specification is not limited to a right-angled corner portion, but may be an obtuse-angled corner portion or an acute-angled corner portion. Further, the “corner portion” may have an inclined surface (C chamfered surface) like the corner portion c1.

The insulating member 71 of the upper wall 21 is arranged along the wall surface S1 of the second inner wall portion 81b of the upper wall 21, and has an end portion 71a located at the corner portion c1. In the present specification, “the end of the insulating member is located at the corner” means that the end of the insulating member overlaps the corner when viewed in the vertical direction or the front-back direction of the refrigerator 1, or the end of the insulation member is located near the corner.

The insulating member 72 of the rear wall 25 is arranged along the wall surface S3 of the inner wall portion 91 of the rear wall 25, and has an end portion 72a located at the corner portion c1. The end portion 72a of the insulating member 72 of the rear wall 25 is abutted with the end portion 71a of the insulating member 71 of the upper wall 21 at the corner portion c1. That is, the end portion 72a of the insulating member 72 of the rear wall 25 is in contact with the end portion 71a of the insulating member 71 of the upper wall 21. As a result, the insulating member 71 of the upper wall 21 and the insulating member 72 of the rear wall 25 form a large continuous heat insulating layer. According to such a configuration, the heat insulating property can be further improved.

### 4.3.3 Configuration Related to Inner Insulating Member (2)

Next, the configuration of the insulating member 72 from another viewpoint will be described.

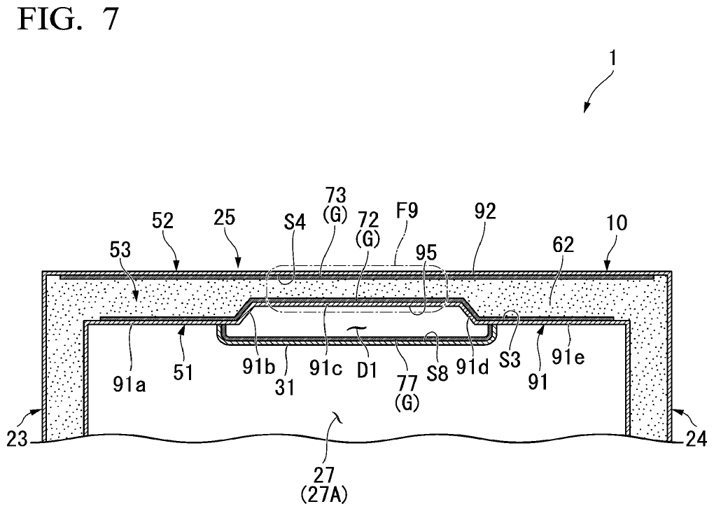

FIG. 7 is a cross-sectional view taken along the line F7-F7 of the refrigerator 1 shown in FIG. 5. In the present embodiment, the inner wall portion 91 of the rear wall 25 has a recess 95 that is recessed toward the rear. The recess 95 is located behind the first duct component 31. The first duct space D1 described above is formed between the first duct component 31 and the recess 95 of the rear wall 25. According to such a configuration, the thickness of the first duct component 31 in the front-rear direction of the refrigerator 1 can be reduced, and the internal volume of the refrigerator 1 can be increased.

More specifically, the inner wall portion 91 has a first portion 91a, a second portion 91b, a third portion 91c, a fourth portion 91d, and a fifth portion 91e

The first portion 91a and the fifth portion 91e extend in the left-right direction (horizontal width direction) of the refrigerator 1, and are located on the frontmost side of the first to fifth portions 91a, 91b, 91c, 91d, 91e. The first portion 91a and the fifth portion 91e are located on the left and right sides of the third portion 91c. The third portion 91c extends in the left-right direction of the refrigerator 1 and is located closer to the outer wall portion 92 as compared with the first portion 91a and the fifth portion 91e.

The second portion 91b extends so as to be inclined with respect to the left-right direction of the refrigerator 1, for example, and connects the right end of the first portion 91a and the left end of the third portion 91c. The fourth portion 91d extends so as to be inclined with respect to the left-right direction of the refrigerator 1, for example, and connects the left end of the fifth portion 91e and the right end of the third portion 91c.

The insulating member 72 is formed in a flexible sheet shape, is deformed into the recess 95 according to the shape, and is arranged along the inner wall portion 91. In the present embodiment, the insulating member 72 is bent so as to be continuously along the first portion 91a, the second portion 91b, the third portion 91c, the fourth portion 91d, and the fifth portion 91e, and is arranged along the first to fifth portions 91a, 91b, 91c, 91d, 91e, respectively. The insulating member 72 is fixed to the first to fifth portions 91a, 91b, 91c, 91d, 91e by an adhesive layer similar to the above-mentioned adhesive layer h, respectively, and is in contact with each of the first to fifth portions 91a, 91b, 91c, 91d, 91e, respectively.

### 4.3.4 Configuration Related to Outer Insulating Member (1)

Next, the configuration regarding the outer insulating member 73 will be described.

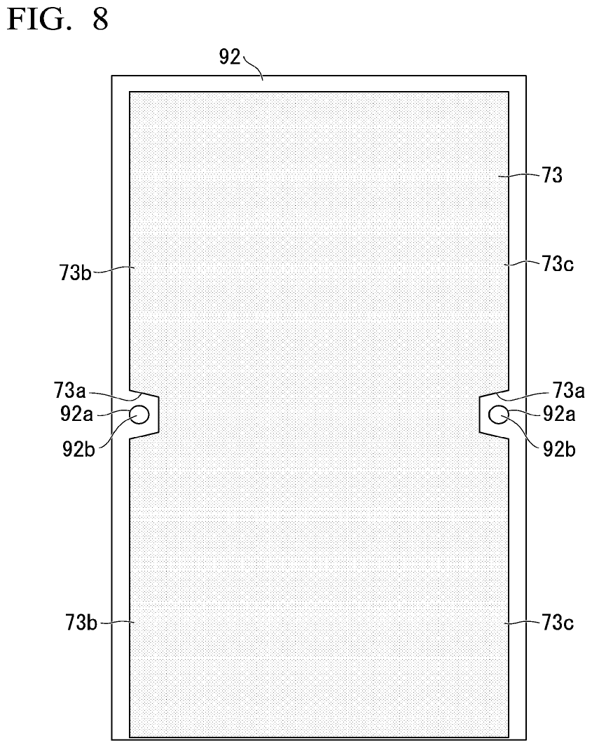

FIG. 8 is a front view showing the insulating member 73 and the outer wall portion 92. The outer wall portion 92 has a plurality of injection ports 92a into which the foam insulation material 62 before foaming is injected. The foam insulation material 62 is injected into the space between the inner box 51 and the outer box 52 through the injection port 92a, and is foamed in the space between the inner box 51 and the outer box 52. The plurality of injection ports 92a are arranged at the left and right ends of the outer wall portion 92, for example. The inlet 92a is closed with a lid 92b attached after the foam insulation material 62 is injected.

In the present embodiment, the insulating member 73 is formed in a rectangular shape that covers most of the outer wall portion 92, and has a notch (or hole) 73a that avoids a plurality of injection ports 92a of the outer wall portion 92. By providing the insulating member 73 with a notch (or a hole) 73a, it becomes easy to attach the insulating member 73 near the plurality of injection ports 92a. The insulating member 73 can cover most of the outer wall portion 92 except for the injection port 92a. For example, the insulating member 73 has a first overhanging portion 73b protruding to the left side of at least a part of the left injection port 92a, and a second overhanging portion 73c protruding to the right side of at least a part of the right injection port 92a, and has a relatively large outer shape.

Such a shape that covers the outer wall portion 92 while leaving only the region close to the injection port 92a is difficult to manufacture with the vacuum insulation material that is difficult to form a partial cutout portion or a hole portion.

### 4.3.5 Configuration Related to Outer Insulating Member (2)

Next, the configuration of the insulating member 73 from another viewpoint will be described.

FIG. 9 is an enlarged cross-sectional view showing a region surrounded by the F9 line of the refrigerator 1 shown in FIG. 7. In the present embodiment, the refrigerator 1 includes a heat radiating pipe 101 arranged along the outer wall portion 92 of the rear wall 25. The heat radiating pipe 101 is a component to which the refrigerant compressed by the compressor 17 is supplied and the heat of the refrigerant is released. The heat radiating pipe 101 is an example of a “heat radiating member”.

In the present embodiment, the insulating member 73 is formed of the specific heat insulation material G and has elasticity. The insulating member 73 is located on the side opposite to the outer wall portion 92 of the rear wall 25 with respect to the heat radiating pipe 101, and is located between the foam insulation material 62 and the heat radiating pipe 101. The insulating member 73 is in contact with the heat radiating pipe 101.

For example, the insulating member 73 is sandwiched between the foam insulation material 62 and the heat radiating pipe 101 when the foam insulation material 62 is foamed, and is compressed between the foam insulation material 62 and the heat radiating pipe 101. The insulating member 73 exerts an elastic force due to compression on the heat radiating pipe 101, and presses the heat radiating pipe 101 toward the outer wall portion 92 of the rear wall 25. As a result, the heat radiating pipe 101 comes into contact with the outer wall portion 92 of the rear wall 25, and the thermal connectivity between the heat radiating pipe 101 and the outer wall portion 92 of the rear wall 25 is improved. As a result, the heat of the heat radiating pipe 101 is easily transferred to the outer wall portion 92 of the rear wall 25, and the heat radiating property of the heat radiating pipe 101 is improved.

More specifically, in the present embodiment, the insulating member 73 includes, for example, a main body portion 105 and a metal portion 106. The main body 105 is formed of the above-mentioned specific heat insulation material G and has elasticity. The metal portion 106 is provided on the surface of at least a part of the main body portion 105. In the present embodiment, the metal portion 106 is provided on the surface of the main body portion 105 facing the heat radiating pipe 101 and the outer wall portion 92 of the rear wall 25. In other words, the metal portion 106 is located between the main body portion 105 and the heat radiating pipe 101 and the outer wall portion 92 of the rear wall 25. The metal portion 106 is a thin metal layer (for example, a metal foil) and has flexibility (flexibility). The metal portion 106 can be deformed following the elastic deformation of the main body portion 105.

The metal portion 106 has a first portion 106a and a second portion 106b. The first portion 106a faces the heat radiating pipe 101 in the thickness direction of the rear wall 25. The second portion 106b is located away from the heat radiating pipe 101 in the thickness direction of the rear wall 25 and faces the outer wall portion 92 of the rear wall 25. The main body 105 is sandwiched between the first portion 106a and the second portion 106b of the metal portion 106 and the foam insulation material 62 and compressed.

The insulating member 73 exerts an elastic force due to compression of the main body 105 on the first portion 106a of the metal portion 106, and presses the first portion 106a of the metal portion 106 toward the heat radiating pipe 101. For example, the first portion 106a of the metal portion 106 is deformed so as to wrap a part of the outer peripheral surface of the heat radiating pipe 101 and comes into contact with the outer peripheral surface of the heat radiating pipe 101. As a result, the thermal connectivity between the metal portion 106 and the heat radiating pipe 101 is improved.

Similarly, the insulating member 73 exerts an elastic force due to compression of the main body 105 on the second portion 106b of the metal portion 106, and presses the second portion 106b of the metal portion 106 toward the outer wall portion 92 of the rear wall 25. As a result, the metal portion 106 comes into contact with the outer wall portion 92 of the rear wall 25, and the thermal connectivity between the metal portion 106 and the outer wall portion 92 of the rear wall 25 is improved. As a result, the heat radiating pipe 101 and the outer wall portion 92 of the rear wall 25 are more firmly thermally connected via the metal portion 106, and a part of the heat of the heat radiating pipe 101 is transferred to the outer wall portion 92 of the rear wall 25 via the metal portion 106. As a result, the heat dissipation of the heat dissipation pipe 101 can be further improved. The heat radiation pipe 101 and the outer wall portion 92 of the rear wall 25, the first portion 106a of the metal portion 106 and the heat dissipation pipe 101, and the second portion 106b of the metal portion 106 and the outer wall portion 92 of the rear wall 25 are in direct contact with each other. Alternatively or additionally, a member having good thermal conductivity may be interposed between them to indirectly contact them.

### 4.4 Lower Wall of Housing

### 4.4.1 Overview of the Lower Wall

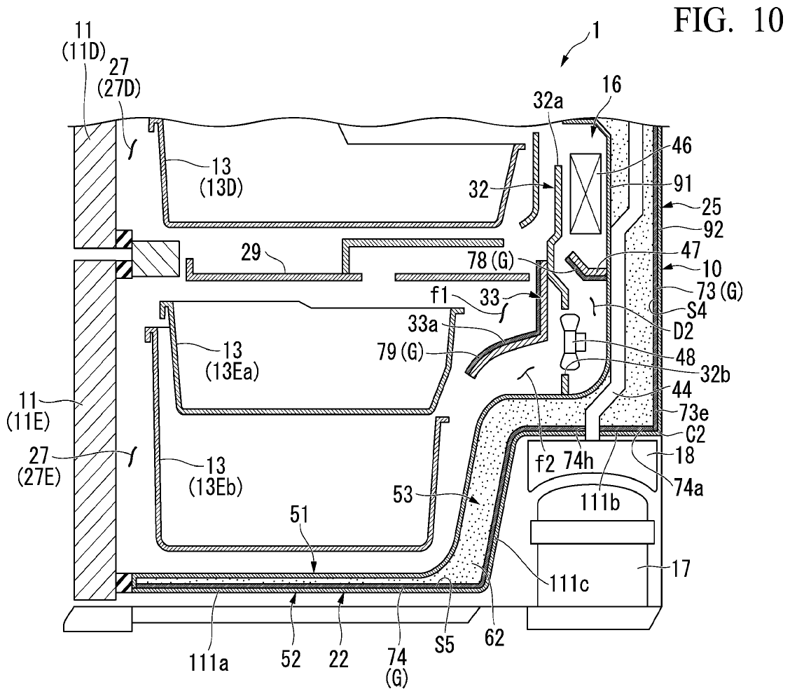

Next, the lower wall 22 of the housing 10 will be described with reference to FIG. 10. The lower wall 22 includes, for example, an insulating member 74.

FIG. 10 is a cross-sectional view showing the lower wall 22 of the housing 10.

The outer box 52 has a first outer wall portion 111a, a second outer wall portion 111b, and an inclined outer wall portion (third outer wall portion) 111c included in the lower wall 22 of the housing 10.

The first outer wall portion 111a extends substantially horizontally from the front end of the housing 10 toward the rear.

The second outer wall portion 111b is located behind the first outer wall portion 111a and extends substantially horizontally. The second outer wall portion 111b is located at a height higher than that of the first outer wall portion 111a. At least a part of the second outer wall portion 111b is located above the compressor 17 and the evaporating dish 18.

The inclined outer wall portion 111c is provided between the first outer wall portion 111a and the second outer wall portion 111b, and is inclined obliquely with respect to the horizontal direction. The inclined outer wall portion 111c connects the rear end of the first outer wall portion 111a and the front end of the second outer wall portion 111b.

The outer box 52 has a wall surface S5 facing a region (that is, a heat insulating portion 53) between the inner box 51 and the outer box 52. The wall surface S5 is the upper surface of the first outer wall portion 111a, the second outer wall portion 111b, and the inclined outer wall portion 111c. The wall surface S5 has a wall surface shape corresponding to the shapes of the first outer wall portion 111a, the second outer wall portion 111b, and the inclined outer wall portion 111c.

The insulating member 74 is arranged between the inner box 51 and the outer box 52. The insulating member 74 is formed of the above-mentioned specific heat insulation material G and has flexibility. The insulating member 74 is arranged along the wall surface S5 of the outer box 52. For example, the insulating member 74 is fixed to the wall surface S5 of the outer box 52 by an adhesive layer similar to the adhesive layer h described above, and is in contact with the wall surface S5 of the outer box 52. In the present embodiment, the insulating member 74 has a size over substantially the entire area of the first outer wall portion 111a, the inclined outer wall portion 111c, and the second outer wall portion 111b. The insulating member 74 is formed in a flexible sheet shape, is deformed into a shape that conforms to the wall shape of the outer box 52, and is arranged along the wall surface S5 of the outer box 52. In the present embodiment, the foam insulation material 62 is filled between the insulating member 74 and the inner box 51.

### 4.4.2 Configuration Related to Insulating Member (1)

Next, the configuration of the insulating member 74 will be described.

The wall surface S5 of the second outer wall portion 111b of the lower wall 22 extends in a direction different from that of the wall surface S4 of the outer wall portion 92 of the rear wall 25. A corner portion c2 is provided between the wall surface S5 of the second outer wall portion 111b of the lower wall 22 and the wall surface S4 of the outer wall portion 92 of the rear wall 25. The wall surface S4 of the outer wall portion 92 of the rear wall 25 is another example of the “first wall surface”. The wall surface S5 of the second outer wall portion 111b of the lower wall 22 is another example of the “second wall surface”.

The insulating member 73 of the rear wall 25 is arranged along the wall surface S4 of the outer wall portion 92 of the rear wall 25, and has an end portion 73e located at the corner portion c2. The insulating member 74 of the lower wall 22 is arranged along the wall surface S5 of the second outer wall portion 111b of the lower wall 22, and has an end portion 74a located at the corner portion c2. The end portion 74a of the insulating member 74 of the lower wall 22 is abutted with the end portion 73e of the insulating member 73 of the rear wall 25 at the corner portion c2. That is, the end portion 74a of the insulating member 74 of the lower wall 22 is in contact with the end portion 73e of the insulating member 73 of the rear wall 25. As a result, the insulating member 74 of the lower wall 22 and the insulating member 73 of the rear wall 25 form a large series of heat insulating layer. According to such a configuration, the heat insulating property can be further improved.

### 4.4.3 Configuration Related to Insulating Member (2)

Next, the configuration of the insulating member 74 from another viewpoint will be described.

As shown in FIG. 2, between the rear wall 25 of the housing 10 and the evaporating dish 18, the defrost water received by the first defrost water receiver 42 and the second defrost water receiver 47 is placed in the evaporating dish 18. The drainage pipe portion 44 to guide is extended. The drainage pipe portion 44 is, for example, a drainage pipe or a drainage hose.

As shown in FIG. 10, the insulating member 74 of the lower wall 22 has an insertion portion 74h through which the drainage pipe portion 44 is passed. The insertion portion 74h is, for example, a hole portion that penetrates the insulating member 74 in the thickness direction, but may be a cutout portion cut out from the outer edge of the insulating member 74. Since the insulating member 74 has the insertion portion 74h, it becomes easy to attach the insulating member 74 to the outer circumference or the vicinity of the outer circumference of the drainage pipe portion 44. The insulating member 74 can be formed in a size and shape that can cover most of the wall surface S5 except for the drainage pipe portion 44. For example, the insulating member 74 includes portions arranged on the front side, the rear side, the left side, and the right side of the drain pipe portion 44, and insulates between the compressor 17 and the inside of the housing 10. According to such a configuration, the heat of the compressor 17 is less likely to be transferred to the inside of the housing 10, and it is possible to suppress the formation of dew condensation on the surface of the lower wall 22.

For example, the insulating member 74 has a slit SL that connects the insertion portion 74h, which is a hole portion, and the insertion portion 74h and the outer edge of the insulating member 74. The slit SL of the insulating member 74 is substantially the same as the slit SL of the insulating member 78 (see FIG. 19), which will be described later. For example, the width W of the slit gap of the insulating member 74 is smaller than the width (for example, diameter) of the drain pipe portion 44. The drainage pipe portion 44 can be positioned at the insertion portion 74h by being passed through the slit SL while deforming (for example, elastically deforming) the periphery of the slit of the insulating member 74. According to such a configuration, a large heat insulating layer surrounding the outer periphery of the drainage pipe portion 44 can be provided while avoiding the drainage pipe portion 44.

### 4.5 Left and Right Side Walls of the Housing

### 4.5.1 Outline of Left and Right Side Walls

Next, the left side wall 23 and the right side wall 24 of the housing 10 will be described. The left side wall 23 and the right side wall 24 have substantially the same configuration as each other. Therefore, in the following, the left side wall 23 will be described as representative.

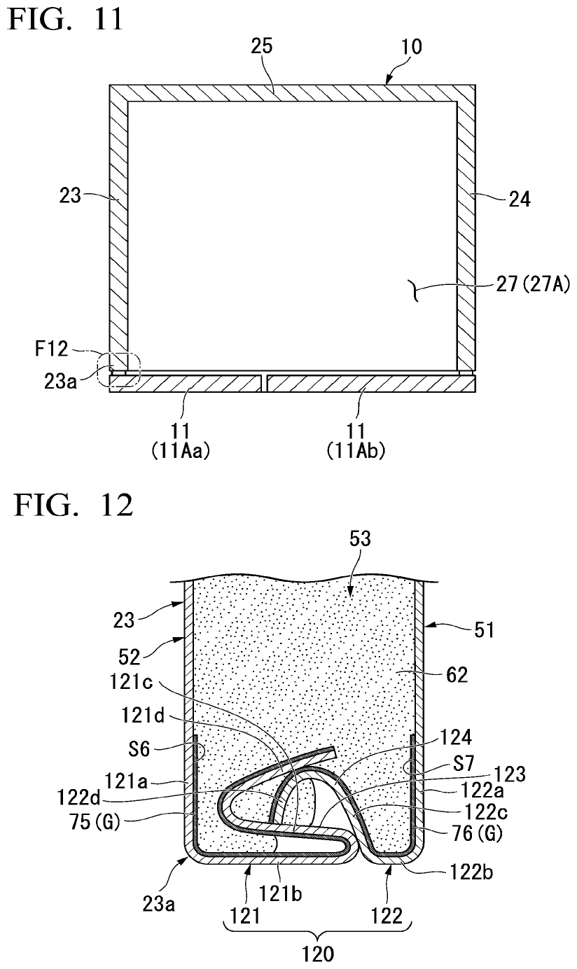

FIG. 11 is a cross-sectional view taken along the line F11-F11 of the refrigerator 1 shown in FIG. 2. However, FIG. 11 schematically shows the main part of the housing 10. Therefore, the illustration of the inside of the refrigerator compartment 27A is omitted.

The left side wall 23 has a front end portion 23a. The front end portion 23a faces, for example, the left refrigerating chamber door 11Aa.

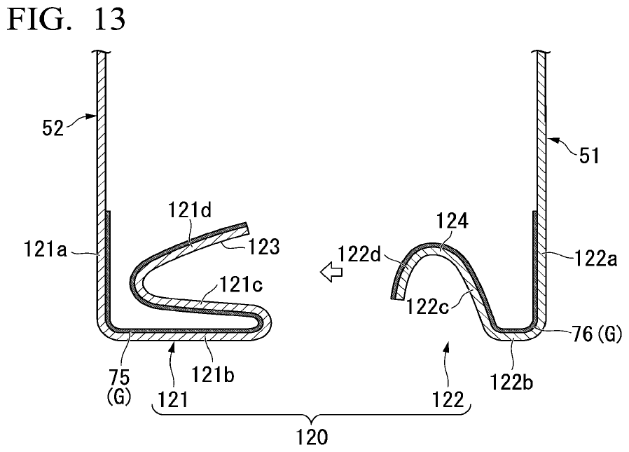

FIG. 12 is an enlarged cross-sectional view showing a region of the left side wall 23 shown in FIG. 11 surrounded by the F12 line. FIG. 13 is an exploded cross-sectional view showing the structure shown in FIG. 12. As shown in FIGS. 12 and 13, the front end portion 23a of the left side wall 23 is provided with a connection structure 120 for connecting the inner box 51 and the outer box 52. The connection structure 120 includes, for example, a first connection portion 121 provided at the tip end portion of the outer box 52 and a second connection portion 122 provided at the tip end portion of the inner box 51.

More specifically, the first connecting portion 121 has a first portion 121a, a second portion 121b, a third portion 121c, and a fourth portion 121d. The first portion 121a extends in the front-rear direction of the refrigerator 1. The second portion 121b is bent from the front end of the first portion 121a toward the right side of the refrigerator 1. The second portion 121b is located on the foremost side of the left side wall 23 and forms a part of the front surface of the left side wall 23. The third portion 121c is folded back from the tip of the second portion 121b toward the outside of the refrigerator 1 and extends inside the left side wall 23. The fourth portion 121d is bent rearward from the tip of the third portion 121c and toward the inside of the refrigerator 1 and extends inside the left side wall 23. The third portion 121c and the fourth portion 121d form a recess 123 with which the second connecting portion 122 engages.

The second connecting portion 122 has a first portion 122a, a second portion 122b, a third portion 122c, and a fourth portion 122d. The second portion 122b extends in the front-rear direction of the refrigerator 1. The second portion 122b is bent from the front end of the first portion 122a toward the left side of the refrigerator 1. The second portion 122b is located on the foremost side of the left side wall 23 and forms a part of the front surface of the left side wall 23. The third portion 122c is bent rearward from the tip of the second portion 122b and toward the inside of the refrigerator 1 and extends inside the left side wall 23. The fourth portion 122d is bent forward from the tip of the third portion 122c and toward the outside of the refrigerator 1 and extends inside the left side wall 23. The third portion 122c and the fourth portion 122d form an engaging portion 124 that engages with the recess 123 of the first connecting portion 121.

The foam insulation material 62 is filled between the inner box 51 and the outer box 52. However, it is difficult for the foamed heat insulating material 62 to be filled, for example, between the second portion 121b and the third portion 121c of the first connecting portion 121, or between the third portion 121c of the first connecting portion 121 and the third and fourth portions 122c and 122d of the second connecting portion 122. Therefore, the heat insulating property of the tip of the left side wall 23 is unlikely to be high.

### 4.5.2 Configuration Related to Insulating Member

In this embodiment, the left side wall 23 has insulating members 75 and 76. The insulating members 75 and 76 are provided between the inner box 51 and the outer box 52. Each of the insulating members 75 and 76 is formed of the above-mentioned specific heat insulation material G.

More specifically, the outer box 52 has a wall surface S6 facing a region (that is, a region filled with the foam insulation material 62, a heat insulating portion 53) between the inner box 51 and the outer box 52.

The insulating member 75 is arranged along the wall surface S6 of the outer box 52. In the present embodiment, the insulating member 75 is fixed to the first to fourth portions 121a, 121b, 121c, 121d of the first connecting portion 121 by an adhesive layer similar to the above-mentioned adhesive layer h, respectively, and is in contact with the first to fourth portions 121a, 121b, 121c, 121d, respectively. For example, in the first connecting portion 121, the insulating member 75 is fixed in a flat state during manufacturing, and then the insulating member 75 is bent together with the insulating member 75 by press working or the like, so that the first to fourth portions 121a, 121b, 121c, 121d described above are formed.

Similarly, the inner box 51 has a wall surface S7 facing a region (that is, a region filled with the foam insulation material 62, a heat insulating portion 53) between the inner box 51 and the outer box 52. The insulating member 76 is arranged along the wall surface S7 of the inner box 51. In the present embodiment, the insulating member 76 is fixed to the first to fourth portions 122a, 122b, 122c, 122d of the second connecting portion 122 by an adhesive layer similar to the above-mentioned adhesive layer h, respectively, and is in contact with the first to fourth portions 122a, 122b, 122c, 122d, respectively.

In the present embodiment, in the front-rear direction of the refrigerator 1, at least a part of the insulating member 75 attached to the first connecting portion 121 and the insulating member 76 attached to the second connecting portion 122 overlap each other. As a result, the heat insulating property of the tip of the left side wall 23 is enhanced. Even when only one of the insulating members 75 and 76 is provided, the heat insulating property of the tip of the left side wall 23 can be improved to some extent.

### 5. Insulation Structure of Parts Inside the Housing

Next, the heat insulating structure of the parts arranged in the housing 10 will be described.

### 5.1 First Duct Parts

### 5.1.1 Configuration Related to the First Duct Component (1)

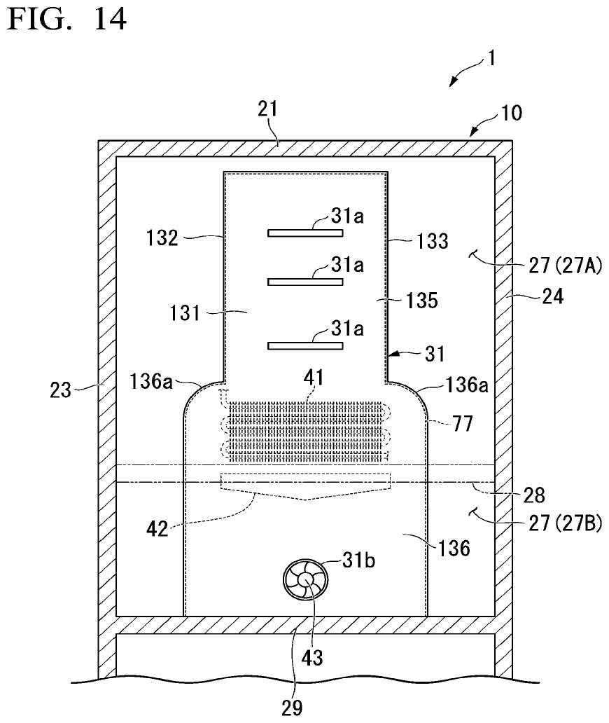

FIG. 14 is a cross-sectional view of the refrigerator 1 as viewed from the front. The first duct component 31 has a front wall portion 131, a left side wall portion 132, and a right side wall portion 133.

The front wall portion 131 extends in the left-right direction of the refrigerator 1 with a first duct space D1 (see FIG. 2; not shown in FIG. 14) between the front wall portion 131 and the inner wall portion 91 of the rear wall 25 of the refrigerator 1 described above. The left side wall portion 132 extends from the left end of the front wall portion 131 toward the inner wall portion 91 of the rear wall 25 of the refrigerator 1, and is connected to the inner wall portion 91 of the rear wall 25. The right side wall portion 133 extends from the right end of the front wall portion 131 toward the inner wall portion 91 of the rear wall 25 of the refrigerator 1, and is connected to the inner wall portion 91 of the rear wall 25. The first duct component 31 has a back surface S8 (see FIG. 7) facing the first duct space D1. The back surface S8 is formed over the front wall portion 131, the left side wall portion 132, and the right side wall portion 133.

From another point of view, the first duct component 31 has a first region 135 and a second region 136 located below the first region 135. The first region 135 is located, for example, behind the refrigerator compartment 27A. The first region 135 has a plurality of cold air outlets 31a. The width of the first region 135 in the left-right direction of the refrigerator 1 is narrower than that of the second region 136, which will be described later. The second region 136 is located, for example, behind the vegetable compartment 27B and behind the lower end of the refrigerator compartment 27A. The second region 136 has the cold air return port 31b open and houses the first cooler 41, the first defrost water receiver 42, and the first fan 43. The outer shape of the upper end portion of the second region 136 has an arc portion 136a whose width gradually decreases as it approaches the first region 135.

An insulating member 77 is attached to the back surface S8 of the first duct component 31 (see FIG. 2). The insulating member 77 is formed of the above-mentioned specific heat insulation material G. The insulating member 77 is formed in a sheet shape, for example, and has flexibility. The insulating member 77 is provided over substantially the entire height of the first duct component 31. That is, the insulating member 77 is provided so as to extend above the plurality of cold air outlets 31a of the first duct component 31, passing in front of the first cooler 41 from below the cold air return port 31b of the first duct component 31 and the first fan 43,

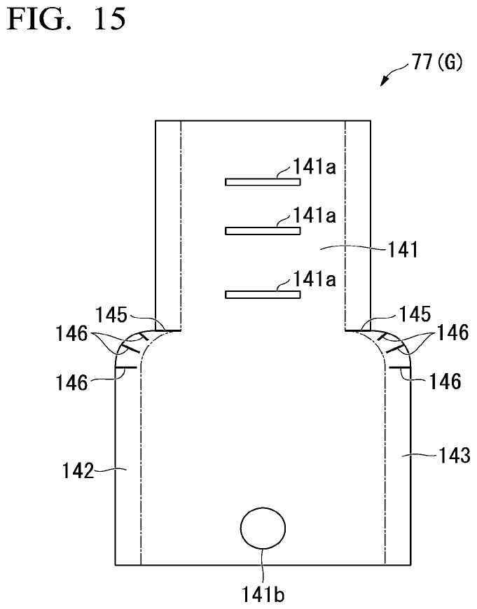

FIG. 15 is a front view showing the insulating member 77 before being attached to the first duct component 31. The insulating member 77 has a central portion 141, a left side portion 142, and a right side portion 143.

The central portion 141 has a shape corresponding to the front wall portion 131 of the first duct component 31. The central portion 141 has openings 141a and 141b corresponding to the cold air outlet 31a and the cold air return port 31b of the first duct component 31, respectively.

The left side portion 142 projects to the left from the central portion 141, and has a shape corresponding to the left side wall portion 132 of the first duct component 31. The right side portion 143 projects to the right from the central portion 141, and has a shape corresponding to the right side wall portion 133 of the first duct component 31.

The insulating member 77 is formed as a single flat sheet including a central portion 141, a left side portion 142, and a right side portion 143. The insulating member 77 is attached to the back surface S8 of the first duct component 31 while bending the left side portion 142 and the right side portion 143 with respect to the central portion 141. That is, for example, the central portion 141 of the insulating member 77 is attached to the back surface S8 of the front wall portion 131 of the first duct component 31 by the same adhesive layer as the adhesive layer h described above. Similarly, the left side portion 142 of the insulating member 77 is attached to the back surface S8 of the left side wall portion 132 of the first duct component 31. Similarly, the right side portion 143 of the insulating member 77 is attached to the back surface S8 of the right side wall portion 132 of the first duct component 31.

In the present embodiment, the left side portion 142 and the right side portion 143 of the insulating member 77 have a first notch 145 at a portion corresponding to the boundary between the first region 135 and the second region 136 of the first duct component 31. The first notch 145 extends from the outer edge of the insulating member 77 toward the inside of the insulating member 77. By providing the first notch 145, the insulating member 77 can be easily attached without being affected by the difference in width between the first region 135 and the second region 136 of the first duct component 31. The first notch 145 has a length over the entire width of each of the left side portion 142 and the right side portion 143, for example.

The left side portion 142 and the right side portion 143 of the insulating member 77 have one or more (for example, a plurality of) second notches 146 in the portion corresponding to the arc portion 136a of the first duct component 31. The second notch 146 extends from the outer edge of the insulating member 77 toward the inside of the insulating member 77. By providing the second notch 146, the insulating member 77 can be easily attached without being affected by the shape of the arc portion 136a of the first duct component 31.

### 5.1.2 Configuration Related to the First Duct Component (2)

Next, a configuration relating to the first duct component 31 from another viewpoint will be described.

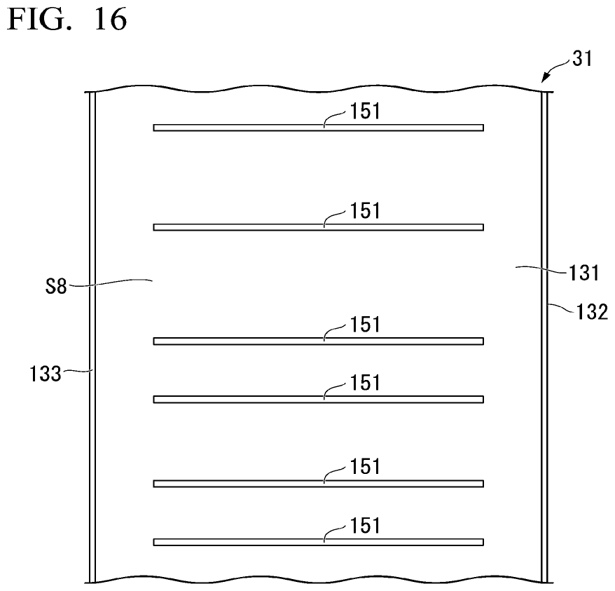

FIG. 16 is a rear view showing the back surface S8 of the first duct component 31. The back surface S8 of the front wall portion 131 of the first duct component 31 has a plurality of convex portions 151. The plurality of convex portions 151 are arranged separately in the vertical direction of the refrigerator 1. The plurality of convex portions 151 extend linearly in the left-right direction of the refrigerator 1, for example. The plurality of convex portions 151 are, for example, reinforcing beads (reinforcing ribs) that reinforce the front wall portion 131 of the first duct component 31.

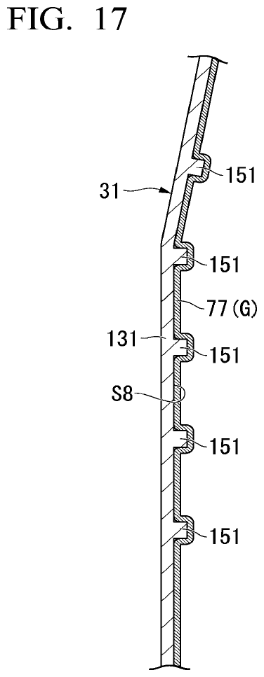

FIG. 17 is a cross-sectional view showing the first duct component 31 and the insulating member 77.

Since the insulating member 77 has flexibility, it is deformed along the wall surface shape of the back surface S8 of the front wall portion 131 including the plurality of convex portions 151, and is attached to the back surface S8 of the front wall portion 131. The insulating member 77 is fixed to each of the regions between the plurality of convex portions 151 and the plurality of convex portions 151 by, for example, an adhesive layer similar to the adhesive layer h described above.

However, the arrangement of the insulating member 77 and the plurality of convex portions 151 is not limited to this.

For example, the insulating member 77 may be attached to the front surface of the first duct component 31 (the surface exposed to the storage chamber 27) instead of being attached to the back surface S8 of the first duct component 31.

For example, the plurality of convex portions 151 may be provided on the front surface of the first duct component 31 instead of the back surface S8 of the first duct component 31.

### 5.2 Defrost Water Receiver

Next, the configuration of the first defrost water receiver 42 and the second defrost water receiver 47 will be described.

The configurations of the first defrost water receiver 42 and the second defrost water receiver 47 are substantially the same as each other. Therefore, in the following, the configuration relating to the first defrosting water receiver 42 will be described as representative.

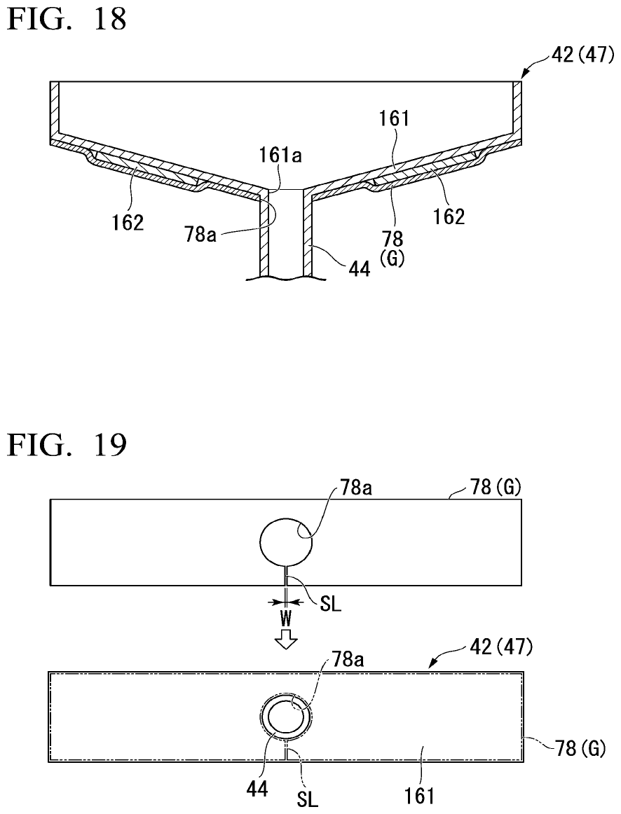

FIG. 18 is a cross-sectional view showing the first defrost water receiver 42 and the drainage pipe portion 44. The first defrost water receiver 42 is formed in a bowl shape that opens upward, for example. The first defrost water receiver 42 has a bottom portion 161 that guides the defrost water dropped from the first cooler 41 toward the drain pipe portion 44. For example, the bottom portion 161 has a hole portion 161a communicating with the drainage pipe portion 44.

In the present embodiment, the heater 162 is attached to the bottom portion 161 of the first defrosting water receiver 42. The heater 162 heats the bottom 161 of the first defrost water receiver 42, and suppresses the defrost water dropped from the first cooler 41 to the first defrost water receiver 42 from freezing in the first defrost water receiver 42.

In the present embodiment, the insulating member 78 is attached to the outer surface of the first defrosting water receiver 42. The insulating member 78 is formed of the specific heat insulation material G described above, and has flexibility, for example. The insulating member 78 is located between the cold air flowing from the lower side to the upper side in the first duct space D1 and the first defrost water receiver 42. As a result, the insulating member 78 prevents the first defrost water receiver 42 from being cooled by the cold air flowing in the first duct space D1. The insulating member 78 is an example of the “fourth insulating member”.

In the present embodiment, the insulating member 78 is located on the side opposite to the first defrosting water receiver 42 with respect to the heater 162 and covers the heater 162. As a result, the temperature of the heater 162 can be suppressed from being lowered by the cold air flowing in the first duct space D1, and the first defrost water receiver 42 can be efficiently heated by the heat of the heater 162.

FIG. 19 is a bottom view showing the first defrost water receiver 42 and the insulating member 78.

The insulating member 78 has an insertion portion 78a through which the drainage pipe portion 44 is passed. The insertion portion 78a is, for example, a hole portion that penetrates the insulating member 78 in the thickness direction, but may be a cutout portion cut from the outer edge of the insulating member 78. By having the insertion portion 78a, the insulating member 78 can be formed in such a size and shape that does not care about the drainage pipe portion 44. For example, the insulating member 78 includes portions arranged on the front side, the rear side, the left side, and the right side of the drain pipe portion 44.

For example, the insulating member 78 has a slit SL that connects the insertion portion 78a, which is a hole portion, and the insertion portion 78a and the outer edge of the insulating member 78. For example, the width W of the gap of the slit SL is smaller than the width (for example, diameter) of the drain pipe portion 44. The drainage pipe portion 44 can be located at the insertion portion 78a by being passed through the slit SL while deforming (for example, elastically deforming) the periphery of the slit SL. As a result, the insulating member 78 can be easily attached to the bottom portion 161 of the first defrost water receiver 42 even after the first defrost water receiver 42 and the drain pipe portion 44 are connected.

### 5.3 Return Flow Path Cover

Next, the configuration relating to the return flow path cover 33 will be described.

As shown in FIG. 10, an insulating member 79 is attached to the return flow path cover 33.

The insulating member 79 is formed of the above-mentioned specific heat insulation material G. The insulating member 79 is attached to, for example, the wall portion 33a of the return flow path cover 33. The wall portion 33a is located behind the main freezing chamber 27E and partitions the rear portion of the housing 10 into a cold air passage f1 and a return passage f2. In other words, the insulating member 79 is located between the cold air passage f1 and the return passage f2.

The cold air flowing through the return flow path f2 may absorb moisture in the process of passing through the ice making chamber 27C, the small freezing chamber 27D, the main freezing chamber 27E, and the like. Therefore, when the cold air passing through the return flow path f2 is cooled by the cold air passing through the cold air flow path f1, dew condensation may occur on the return flow path cover 33. Therefore, in the present embodiment, the insulating member 79 is provided between the cold air passage f1 and the return passage f2. According to such a configuration, it is difficult for the cold air passing through the cold air flow path f1 to cool the cold air containing moisture passing through the return flow path f2, and it is possible to suppress the occurrence of dew condensation on the return flow path cover 33.

According to the above configuration, the heat insulating property of the refrigerator 1 can be improved. That is, in the present embodiment, the refrigerator 1 is arranged between the vacuum insulation material 61 arranged between the inner box 51 and the outer box 52, and between the vacuum insulation material 61 and the inner box 51, and includes a heat insulating member 71 containing aerogel, xerogel, or cryogel, and a foam insulation material 62 which is at least partially filled between the vacuum insulation material 61 and the insulating member 71. According to such a configuration, the vacuum insulation material 61 and the insulating member 71 can secure a high heat insulating property, and the foam insulation material 62 filled between them secures a higher heat insulating property. Therefore, the heat insulating property of the refrigerator 1 can be improved.

According to another viewpoint, the refrigerator 1 is provided between the inner box 51 and the outer box 52 and is arranged along the wall surface of the inner box 51, and includes an insulating member 71 containing aerogel, xerogel, or cryogel. According to such a configuration, even if the shape of the inner box 51 is complicated, the insulating member 71 can form a heat insulating layer that matches the shape of the inner box 51. Thereby, the heat insulating property of the refrigerator 1 can be improved.

### Second Embodiment

Next, the second embodiment will be described. The refrigerator 1 of the second embodiment is different from the first embodiment in that the vacuum insulation material 61 is provided on the rear wall 25 of the housing 10. The configuration other than that described below is the same as that of the first embodiment.

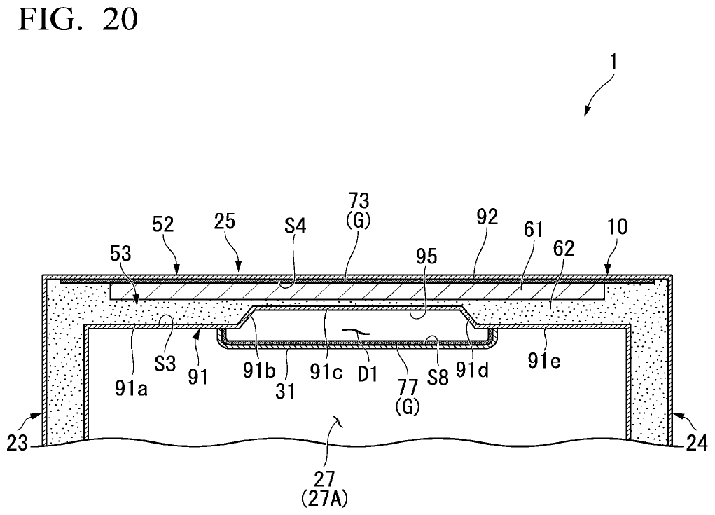

FIG. 20 is a cross-sectional view showing the rear wall 25 of the refrigerator 1 of the second embodiment. In the present embodiment, the rear wall 25 includes, for example, an insulating member 73, a vacuum insulation material 61, and a foam insulation material 62.

The insulating member 73 is arranged along the wall surface S4 of the outer box 52 as in the first embodiment. The insulating member 73 is fixed to the wall surface S4 of the outer box 52 by, for example, an adhesive layer similar to the adhesive layer h described above, and is in contact with the wall surface S4 of the outer box 52.

The vacuum insulation material 61 is arranged between the inner wall portion 91 of the inner box 51 and the outer wall portion 92 of the outer box 52. In the present embodiment, at least a part of the vacuum insulation material 61 is overlapped with the insulating member 73 in the front-rear direction of the refrigerator 1 and is in contact with the insulating member 73. Instead of this, the vacuum insulation material 61 may be arranged away from the insulating member 73, and the foam insulation material 62 may be filled between the vacuum insulation material 61 and the insulating member 73.

The foam insulation material 62 is arranged between the inner wall portion 91 of the inner box 51 and the outer wall portion 92 of the outer box 52. In the present embodiment, at least a part of the foam insulation material 62 is filled on the side opposite to the insulating member 73 with respect to the vacuum insulation material 61. In the present embodiment, the foam insulation material 62 is filled between the vacuum insulation material 61 and the inner wall portion 91 of the inner box 51.

According to such a configuration, the vacuum insulation material 61 and the insulating member 73 can ensure high heat insulating properties, and further higher heat insulating properties are ensured by the foam insulation material 62 filled on the side opposite to the insulating member 73 with respect to the vacuum insulation material 61. Therefore, the heat insulating property of the refrigerator 1 can be improved.

At least a part of the vacuum insulation material 61 may be superposed on the insulating member 72 (see FIG. 7) along the wall surface S3 of the inner box 51 instead of the insulating member 73 along the wall surface S4 of the outer box 52, and may be in contact with the insulating member 72. In this case, at least a part of the foam insulation material 62 may be filled on the side opposite to the insulating member 72 with respect to the vacuum insulation material 61. That is, the foam insulation material 62 may be filled between the vacuum insulation material 61 and the outer wall portion 92 of the outer box 52. Further, the configuration described as the second embodiment is not limited to the rear wall 25 of the housing 10, and may be applied to the upper wall 21, the lower wall 22, the left side wall 23, and the right side wall 24.

### Third Embodiment

Next, a third embodiment will be described. The refrigerator 1 of the third embodiment is different from the first embodiment in that a vacuum insulation material 170 different from the general vacuum insulation material is provided. The configuration other than that described below is the same as that of the first embodiment.

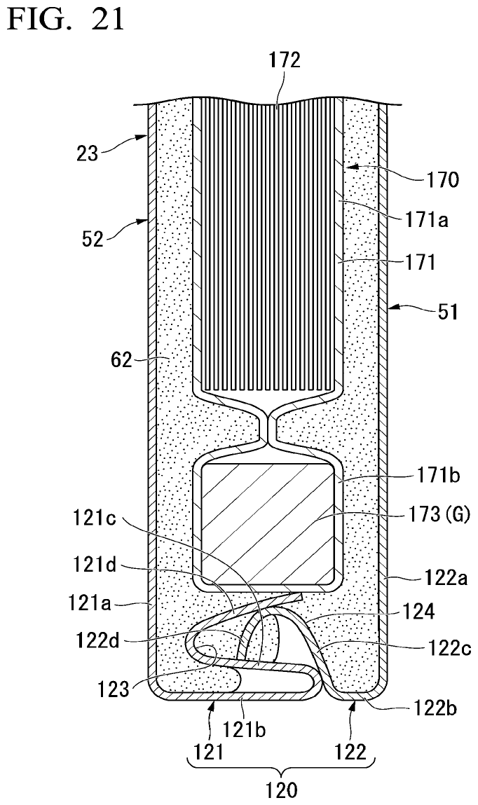

FIG. 21 is a cross-sectional view showing the left side wall 23 of the refrigerator 1 of the third embodiment. In this embodiment, the left wall 23 includes the vacuum insulation material 170. The vacuum insulation material 170 is arranged between the inner box 51 and the outer box 52.

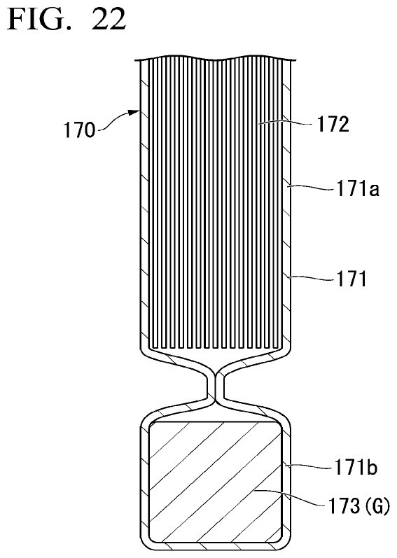

FIG. 22 is a cross-sectional view showing the vacuum insulation material 170. The vacuum insulation material 170 has, for example, an exterior body 171, a core material 172, and an insulating member 173.

The exterior body 171 is made of the same material as the exterior body of a general vacuum insulation material, for example. The exterior body 171 is an airtight cover, and has a size that covers the core material 172 and the insulating member 173. The exterior body 171 has a first portion 171a and a second portion 171b which is an end portion of the exterior body 171. A core material 172 is housed in the first portion 171a of the exterior body 171. An insulating member 173 is housed in the second portion 171b of the exterior body 171. At least the first portion 171a of the exterior body 171 is depressurized. In the present embodiment, both the first portion 171a and the second portion 171b are decompressed by reducing the pressure inside the exterior body 171 after the core material 172 and the insulating member 173 are housed in the exterior body 171.

The core material 172 is made of the same material as the core material of a general vacuum insulation material. The core material 172 is, for example, a fiber material such as glass wool or a porous body such as a foam. For example, the core material 172 is formed by laminating a plurality of relatively thinly formed fibrous materials or porous bodies.

The insulating member 173 is formed of the above-mentioned specific heat insulation material G. The insulating member 173 preferably has elasticity, for example, but does not have to have elasticity.

In the present embodiment, after the core material 172 and the insulating member 173 as described above are housed in the exterior body 171, the space between the first portion 171a and the second portion 171b is airtightly closed by welding or the like. In other words, the first portion 171a and the second portion 171b are airtightly separated. As a result, even if the exterior body 171 is torn in the second portion 171b, the airtightness (vacuum degree) of the first portion 171a is ensured. The second portion 171b may be provided only at one end of the vacuum insulation material 170, but may be provided at two or more ends of the vacuum insulation material 170, or may be provided on the entire circumference of the vacuum insulation material 170.

As shown in FIG. 21, the vacuum insulation material 170 having the above configuration is inserted into the left side wall 23 of the housing 10 from the rear to the front with the second portion 171b at the head. At that time, in the case of a general vacuum insulation material, when the vacuum insulation material is inserted into the left side wall 23, the vacuum insulation material may come into contact with the internal structure (for example, the connection structure 120) of the left side wall 23, and the exterior body may be damaged.

If the exterior body is damaged, the degree of vacuum inside the vacuum insulation material is lowered, so that the performance of the vacuum insulation material may be deteriorated. Therefore, it is difficult to insert the vacuum insulation material to the depth where it may come into contact with the internal structure.

On the other hand, the vacuum insulation material 170 of the present embodiment has an insulating member 173 at the end of the vacuum insulation material 170 and is provided with a second portion 170b which does not cause any problems even if the exterior body 171 is damaged. As a result, even if the vacuum insulation material 170 comes into contact with the internal structure of the left side wall 23 (for example, the connection structure 120), the performance of the vacuum insulation material 170 does not deteriorate, so that it can be inserted all the way to the back of the left side wall 23 (near the front end).

Thereby, the heat insulating property of the refrigerator 1 can be improved. For example, in the example shown in FIG. 21, the vacuum insulation material 170 is in contact with the internal structure (for example, the connection structure 120) of the left side wall 23.

### Fourth Embodiment

Next, a fourth embodiment will be described. The refrigerator 1 of the fourth embodiment is different from the first embodiment in that the insulating member 73 of the rear wall 25 is divided into a plurality of members. The configuration other than that described below is the same as that of the first embodiment.

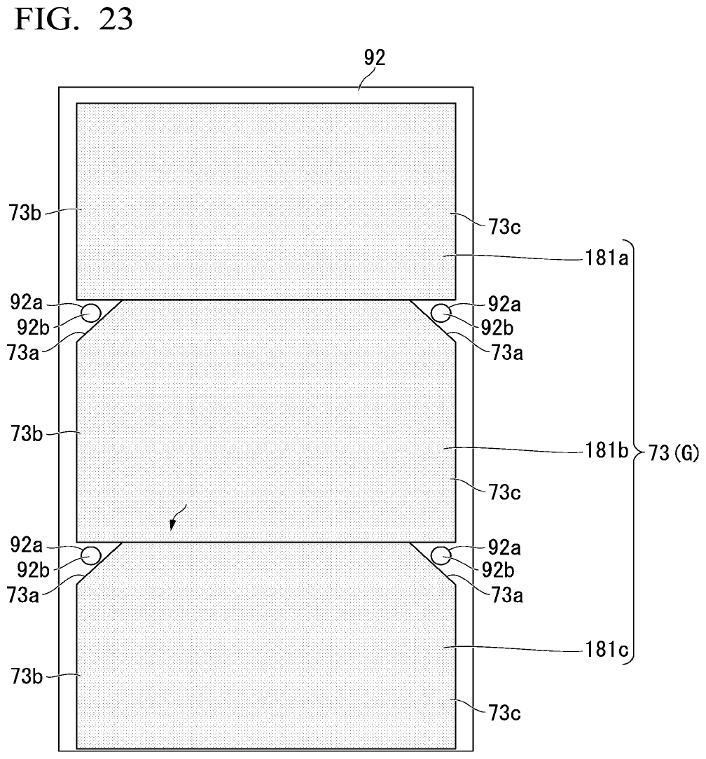

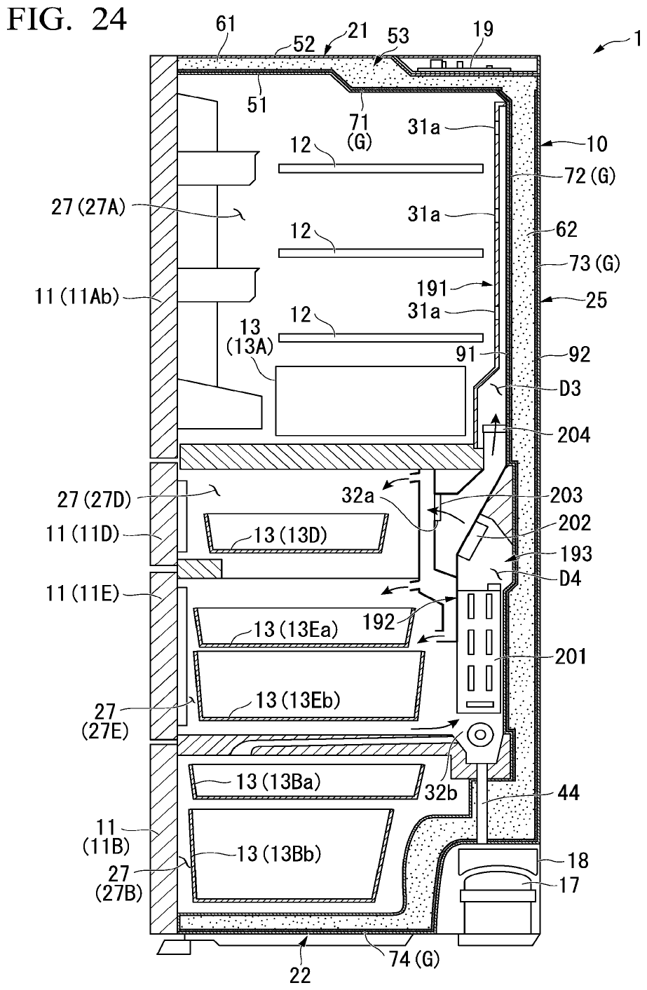

FIG. 23 is a front view showing the insulating member 73 and the outer wall portion 92 of the rear wall 25 of the housing 10.

In the present embodiment, the insulating member 73 is divided into a plurality of members 181a, 181b, and 181c in the direction along the wall surface S4 of the outer wall portion 92 (for example, the vertical direction of the refrigerator 1). The plurality of members 181a, 181b, and 181c are individually attached to the outer wall portion 92 of the rear wall 25 by, for example, the same adhesive layer as the adhesive layer h described above. According to such a configuration, the workability of attaching the insulating member 73 to the outer wall portion 92 of the rear wall 25 is improved, and the manufacturability of the refrigerator 1 can be improved.

Similar to the above, the insulating member 72 along the inner wall portion 91 of the rear wall portion 25 of the housing 10 may be divided into a plurality of members 181a, 181b, 181c in the direction along the wall surface S3 of the inner wall portion 91 (for example, the vertical direction of the refrigerator 1), and the plurality of members 181a, 181b, 181c may be individually attached to the inner wall portion 91 of the rear wall 25 by, for example, an adhesive layer similar to the adhesive layer h described above.

Further, the configuration described as the fourth embodiment is not limited to the rear wall 25 of the housing 10, and may be applied to the upper wall 21, the lower wall 22, the left side wall 23, the right side wall 24, and the like. Further, the configuration of the insulating member 73 described as the fourth embodiment may be applied to the insulating member 77 attached to the first duct component 31, the insulating member 79 attached to the return flow path cover 33, and the like.

### Fifth Embodiment

Next, a fifth embodiment will be described. The refrigerator 1 of the fifth embodiment is different from the first embodiment in that it includes only one cooler. The configuration other than that described below is the same as that of the first embodiment.

FIG. 24 is a cross-sectional view showing the refrigerator 1 of the fifth embodiment. In the present embodiment, the refrigerating chamber 27A is arranged at the uppermost part, the ice making chamber 27C and the small freezing chamber 27D are arranged below the refrigerating chamber 27A, the main freezing chamber 27E is arranged below the ice making chamber 27C and the small freezing chamber 27D, and the vegetable compartment 27B is arranged below the main freezer compartment 27E.

The refrigerator 1 of the present embodiment includes a first duct component 191 and a second duct component 192, and a cooling unit 193.

The first duct component 191 is arranged behind the refrigerator compartment 27A. The first duct component 191 is provided along the rear wall 25 of the housing 10 and extends in the vertical direction. A first duct space D3, which is a passage through which cold air (air) flows, is formed between the first duct component 191 and the rear wall 25 of the housing 10. The first duct space D3 communicates with the second duct space D4, which will be described later.

The second duct component 192 is arranged behind the ice making chamber 27C, the small freezing chamber 27D, and the main freezing chamber 27E. The second duct component 192 is provided along the rear wall 25 of the housing 10 and extends in the vertical direction. A second duct space D4, which is a passage through which cold air (air) flows, is formed between the second duct component 192 and the rear wall 25 of the housing 10.

The cooling unit 193 includes, for example, a cooler 201, a fan 202, a first damper 203, and a second damper 204. The cooler 201 is arranged in, for example, the second duct space D2. The first damper 203 is provided at the cold air outlet 32a of the second duct component 192, and opens and closes the cold air outlet 32a. The second damper 204 is provided between the first duct component 191 and the second duct component 192, and opens and closes between the first duct space D3 and the second duct space D4.

In the present embodiment, the rear wall 25 includes, for example, an insulating member 72, an insulating member 73, and a foam insulation material 62.

The insulating member 72 is arranged along the wall surface S3 of the inner box 51. For example, the insulating member 72 is provided over substantially the entire height of the rear wall 25 so as to extend from the vicinity of the compressor 17 to the vicinity of the upper end of the refrigerating chamber 27A. That is, the insulating member 72 is provided from the rear of the cooler 201, passes behind the fan 202, the first damper 203, and the second damper 204, and extends behind the plurality of cold air outlets 31a.

The insulating member 73 is arranged along the wall surface S4 of the outer box 52. For example, the insulating member 73 is provided over substantially the entire height of the rear wall 25 so as to extend from the vicinity of the compressor 17 to the vicinity of the upper end of the refrigerating chamber 27A. That is, the insulating member 73 is provided from the rear of the cooler 201, passes behind the fan 202, the first damper 203, and the second damper 204, and extends behind the plurality of cold air outlets 31a.

According to such a configuration, the heat insulating property of the refrigerator 1 can be improved.

So far, some embodiments have been described. However, the embodiments are not limited to the above example. The embodiments described above can be implemented in combination with each other.

In one aspect, in the upper wall 21 of the first embodiment, the vacuum insulation material 61 may be arranged along the wall surface S1 of the inner box 51, and the insulating member 71 may be arranged along the wall surface S2 of the outer box 52. That is, the vacuum insulation material 61 may be attached to the inner box 51, and the insulating member 71 may be attached to the outer box 52. In this case, when the inner box 51 is the first member and the outer box 52 is the second member, the vacuum insulation material 61 is attached to the first member, and the insulating member 71 is attached to the second member.

Even with such a configuration, the foam insulation material 62 easily flows into the gap between the vacuum insulation material 61 and the insulating member 71, and it is possible to prevent the foam insulation material 62 from being insufficiently filled in the gap between the vacuum insulation material 61 and the insulating member 71 and in other parts of the upper wall 21. In this configuration, the insulating member 71 is located between the vacuum insulation material 61 and the outer wall portion 83a of the outer box 52. This configuration is not limited to the upper wall 21 of the housing 10, and may be applied to the lower wall 22, the left side wall 23, the right side wall 24, and the rear wall 25.

Further, according to the first embodiment, the configuration relating to the insulating member 71 of the upper wall 21 of the housing 10, the installation configuration of the power supply circuit portion, the configuration (1) relating to the inner insulating member 72, the configuration (2) relating to the inner insulating member 72, the configuration (1) of the outer insulating member 73, the configuration (2) of the outer insulating member 73, the configuration (1) of the lower wall 22 of the housing 10 with respect to the insulating member 74, the configuration (2) of the lower wall 22 of the housing 10 with respect to the insulating member 74, the configuration of the insulating members 75, 76 of the left side wall 23 and the right side wall 24 of the housing 10, the configuration (1) related to the first duct component 31, the configuration (2) related to the first duct component 31, the configuration relating to the first defrosting water receiver 42 and the second defrosting water receiver 47, and the configuration relating to the return flow path cover may be implemented independently. Even when each of these is carried out independently, it is possible to improve the heat insulating property of the required portion in the refrigerator 1.

According to at least one embodiment described above, the refrigerator is arranged between the vacuum insulation material and the inner surface member or between the vacuum insulation material and the outer surface member, and includes an insulating member containing aerogel, xerogel, or cryogel, and an insulating wall containing a foam insulation material which is at least partially filled between the vacuum insulation material and the insulating member. According to such a configuration, the heat insulating property of the refrigerator can be improved.

Although some embodiments of the present invention have been described, these embodiments are presented as examples and are not intended to limit the scope of the invention. These embodiments can be implemented in various other forms, and various omissions, replacements, and changes can be made without departing from the gist of the invention. These embodiments and modifications thereof are included in the scope and gist of the invention, as well as in the scope of the invention described in the claims and the equivalent scope thereof

### Explanation of Symbols

1 . . . Refrigerator, 10 . . . Housing, 21 . . . Upper wall, 22 . . . Lower wall, 23 . . . Left wall, 24 . . . Right wall, 25 . . . Rear wall, 31 . . . First duct part, 32 . . . Second duct part, 41 . . . First cooler, 42 . . . First defrost water receiver, 46 . . . Second cooler, 47 . . . Second defrost water receiver, 51 . . . Inner box (Inner surface member), 52 . . . Outer box (Outer surface member), 61 . . . Vacuum insulation material, 62 . . . Foam insulation material, 71 to 79 . . . Insulating member, 81a . . . First inner wall part, 81b . . . Second inner wall part, 81c . . . Inclined inner wall part, 83a . . . First outer wall part, 83b . . . Second outer wall part , 83c . . . Inclined outer wall part, 89 . . . Insulation member, 91 . . . Inner wall part, 92 . . . Outer wall part, 92a . . . Injection port, 73a . . . Notch part, 101 . . . Heat dissipation pipe (heat dissipation member), 105 . . . Main body part, 106 . . . Metal part, 111a . . . First outer wall part, 111b . . . Second outer wall part, 111c . . . Inclined outer wall part, 162 . . . Heater, 170 . . . Vacuum insulation material, 171 . . . Exterior body, 172 . . . Core material, 173 . . . Insulating member

1. A refrigerator comprising an insulating wall, wherein the insulating wall includes:
an inner surface member that forms at least a portion of an inner surface of the refrigerator;
an outer surface member that forms at least a portion of an outer surface of the refrigerator;
a vacuum insulation material that is disposed between the inner surface member and the outer surface member;
an insulating member that is disposed between the vacuum insulation material and the inner surface member or between the vacuum insulation material and the outer surface member, and includes an aerogel, axerogel, or a cryogel; and
a foam insulation material, at least a portion of the foam insulation material being used to fill a space between the vacuum insulation material and the insulating member.

2. The refrigerator according to claim 1, wherein a distance between the vacuum insulation material and the insulating member in a thickness direction of the insulating wall is larger than a thickness of the inner surface member or the thickness of the outer surface member in the thickness direction of the insulating wall.

3. The refrigerator according to claim 1, wherein a distance between the vacuum insulation material and the insulating member in a thickness direction of the insulating wall is larger than a thickness of the insulating member in the thickness direction of the insulating wall.

4. The refrigerator according to claim 1, wherein
the vacuum insulation material is attached to a first member of the inner surface member and the outer surface member, and
the insulating member is attached to a second member of the inner surface member and the outer surface member, which is different from the first member.

5. The refrigerator according to claim 1, wherein
the insulating wall includes a first wall portion, a second wall portion extending in a direction different from that of the first wall portion, and a corner portion provided between the first wall portion and the second wall portion, and
the insulating member is formed in a sheet shape and is bent and arranged along the first wall portion, the corner portion, and the second wall portion.

6. The refrigerator according to claim 1, further comprising a heat radiating member arranged along an inner surface of the outer surface member,
wherein the insulating member has elasticity and is sandwiched between the foam insulation material and the heat radiating member to press the heat radiating member toward the inner surface of the outer surface member by an elastic force.

7. The refrigerator according to claim 6, wherein
the insulating member includes an elastic main body including the aerogel, xerogel, or cryogel, and a deformable metal portion provided on a surface of at least a part of the main body,
the metal portion includes a first portion facing the heat radiating member and a second portion facing the inner surface of the outer surface member, and
the insulating member is sandwiched between the foam insulation material and the heat radiating member, so as to be pressed toward an inner surface of the heat radiating member and the outer surface member by the elastic force.

8. A refrigerator comprising an insulating wall, wherein the insulating wall includes:
an inner surface member that forms at least a part of an inner surface of the refrigerator;
an outer surface member that forms at least a part of an outer surface of the refrigerator;
a vacuum insulation material arranged between the inner surface member and the outer surface member;
an insulating member that is arranged between the inner surface member and the outer surface member, and at least a part thereof is arranged so as to overlap the vacuum insulation material, and includes aerogel, xerogel, or cryogel; and
a foam insulation material arranged between the inner surface member and the outer surface member and at least partially filled with respect to the vacuum insulation material on the side opposite to the insulating member.

9. A refrigerator comprising: an exterior body; a core material housed in the exterior body; and an insulating member housed in an end portion of the exterior body and including aerogel, xerogel, or cryogel, wherein at least an area housing the core material in the exterior body is decompressed.

10. The refrigerator according to claim 9, wherein the exterior body includes a first portion containing the core material and a second portion containing the insulating member, and the space between the first portion and the second portion is airtightly closed.
